(19) United States
(12) Patent Application Publication
(10) Pub. No.: US 2008/0212049 A1
(43) Pub. Date: Sep. 4, 2008

(54) SUBSTRATE PROCESSING APPARATUS WITH HIGH THROUGHPUT DEVELOPMENT UNITS

(75) Inventors: Yoshiteru Fukutomi, Kyoto (JP); Masami Ohtani, Kyoto (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Sokudo Co., Ltd., Shimogyo-ku (JP)

(21) Appl. No.: 12/031,673

(22) Filed: Feb. 14, 2008

(30) Foreign Application Priority Data
Feb. 15, 2007 (JP) 2007-034198

(51) Int. Cl. G03B 27/42; G03B 27/52

(52) U.S. Cl. 355/30; 355/53

(57) ABSTRACT

A substrate processing apparatus is arranged adjacent to an exposure device and includes a processing section, a transfer section configured to carry the substrate into and out of the processing section, and an interface configured to receive and transfer the substrate between the processing section and the exposure device. The processing section includes a first processing unit having a photosensitive film formation region, a thermal processing region having a first thermal processing unit, and a first transport region having a first transport unit. The photosensitive film formation region is arranged opposite the thermal processing region with the first transport region interposed therebetween. The processing section also includes a second processing unit having a first development region, a second development region, and a second transport region having a second transport unit. The first development region is arranged opposite to the second development region with the second transport region interposed therebetween.

### CROSS-REFERENCES TO RELATED APPLICATIONS

This application claims priority to Japanese Patent Application 2007-034198, filed Feb. 15, 2007. The disclosure of JP 2007-034198 is hereby incorporated by reference in its entirety for all purposes.

### BACKGROUND OF THE INVENTION

The present invention relates to a substrate processing apparatus that subjects substrates to processing.

Substrate processing apparatuses are used to subject various types of substrates such as semiconductor substrates, substrates for liquid crystal displays, plasma displays, optical disks, magnetic disks, magneto-optical disks, and photomasks, and other substrates to various types of processing.

Such a substrate processing apparatus generally subjects a single substrate to a plurality of different types of processing successively (see, for example, JP 2003-324139). The substrate processing apparatus as described in JP 2003-324139 includes an indexer block, an anti-reflection film processing block, a resist film processing block, a development processing block, and an interface block. An exposure device is arranged adjacent to the interface block as an external device separate from the substrate processing apparatus.

In the above-mentioned substrate processing apparatus, a substrate carried out of the indexer block is transported to the exposure device through the interface block after being subjected to anti-reflection film formation and resist film coating processing in the anti-reflection film processing block and the resist film processing block. After a resist film on the substrate is subjected to exposure processing in the exposure device, the substrate is transported to the development processing block through the interface block. After the resist film on the substrate is subjected to development processing to form a resist pattern thereon in the development processing block, the substrate is transported to the indexer block.

With recent increases in density and integration of devices, making finer resist patterns has become an important problem. Conventional exposure devices have generally performed exposure processing by reduction-projecting reticle patterns on substrates through projection lenses. With such conventional exposure devices, however, the line widths of exposure patterns are determined by the wavelengths of light sources of the exposure devices. Therefore, making finer resist patterns have had limitations.

Therefore, a liquid immersion method is suggested as a projection exposure method allowing for finer exposure patterns (see, for example, WO99/49504 pamphlet). In a projection exposure device according to the WO99/49504 pamphlet, an area between a projection optical system and a substrate is filled with a liquid, resulting in a shorter wavelength of exposure light on a top surface of the substrate. This allows for finer exposure patterns.

In the above-mentioned projection exposure device, however, more accurate development processing is required as the exposure pattern is made finer. Therefore, in recent years, a time period required for development processing is made longer, as compared with those in the conventional exposure devices. When the time period required for the development processing is lengthened, throughput of the whole substrate processing apparatus is reduced. Therefore, there is a need in the art for improved methods and systems for processing substrates.

### SUMMARY OF THE INVENTION

An object of the present invention is to provide a substrate processing apparatus whose throughput in substrate processing can be sufficiently improved.

According to an aspect of the present invention, a substrate processing apparatus that is arranged adjacent to an exposure device includes a processing section that subjects a substrate to predetermined processing, a carry-in/carry-out section for carrying the substrate into and out of the processing section (also referred to as a transfer section), and an interface for receiving and transferring the substrate between the processing section and the exposure device. The processing section includes a first processing unit and a second processing unit.

The first processing unit includes a photosensitive film formation region, a thermal processing region, and a first transport region. The photosensitive film formation region and the thermal processing region are arranged opposite to each other with the first transport region interposed therebetween. The photosensitive film formation region is provided with a photosensitive film formation unit that forms a photosensitive film composed of a photosensitive material on the substrate that has not been subjected to exposure processing by the exposure device. The thermal processing region is provided with a first thermal processing unit that subjects the substrate to thermal processing. The first transport region is provided with a first transport unit that transports the substrate.

The second processing unit includes a first development region, a second development region, and a second transport region. The first and second development regions are arranged opposite to each other with the second transport region interposed therebetween. The first and second development regions are respectively provided with development units that subject the substrate to development processing after exposure processing by the exposure device. The second transport region is provided with a second transport unit that transports the substrate.

In the substrate processing apparatus, the carry-in/carry-out section (i.e., the transfer section) carries the substrate into the processing section. In the first processing unit in the processing section, the photosensitive film formation unit forms the photosensitive film on the substrate, the first thermal processing unit subjects the substrate to the thermal processing, and the first transport unit transports the substrate before or after the formation of the photosensitive film or after the thermal processing.

The first and second transport units transport the substrate on which the photosensitive film has been formed to the interface. The interface carries the substrate that has been transferred from the processing section into the exposure device. Thus, the exposure device subjects the substrate to the exposure processing.

The substrate after the exposure processing is carried out of the exposure device, and is transferred to the interface. The interface further transfers the substrate that has been transferred from the exposure device to the processing section.

In the second processing unit in the processing section, the development unit subjects the substrate after the exposure processing to the development processing, and the second transport unit transports the substrate before or after the development processing. The substrate carry-in/carry-out section carries the substrate after the development processing out of the processing section.

In the second processing unit, the first and second development regions are arranged opposite to each other with the second transport region interposed therebetween. This allows a large number of development units to be provided in the second processing unit. Even when a time period required for the development processing is lengthened, therefore, the large number of development units can subject the substrate to the development processing. As a result, throughput in substrate processing of the whole substrate processing apparatus can be sufficiently improved.

At least one of the first and second development regions may be further provided with a second thermal processing unit that subjects the substrate to thermal processing. In this case, in the second processing unit, the substrate can be quickly subjected to the thermal processing after the development processing. This allows throughput in substrate processing to be improved.

The processing section may further include a third processing unit that may have an anti-reflection film formation region and a third transport region. The anti-reflection film formation region may be provided with an anti-reflection film formation unit that forms an anti-reflection film on the substrate before the photosensitive film formation unit forms the photosensitive film. The third transport region may be provided with a third transport unit that transports the substrate.

In this case, in the third processing unit, the anti-reflection film is formed on the substrate before the formation of the photosensitive film, and the third transport unit transports the substrate before or after the formation of the anti-reflective film. This allows standing waves and halation generated during the exposure processing to be reduced.

The processing section may further include a fourth processing unit that may have a protective film formation region and a fourth transport region. The protective film formation region may be provided with a protective film formation unit that forms a protective film for protecting the photosensitive film before exposure processing by the exposure device. The fourth transport region may be provided with a fourth transport unit that transports the substrate.

In this case, in the fourth processing unit, the protective film formation unit forms the protective film on the substrate before exposure processing on which the photosensitive film has been formed, and the fourth transport unit transports the substrate before or after the formation of the protective film. This can prevent a component of the photosensitive film from being eluted in a liquid even if the exposure device performs the exposure processing with the substrate and the liquid brought into contact with each other. Thus, contamination in the exposure device can be reliably prevented, which can sufficiently prevent processing defects in the substrate.

The processing section may further include a fifth processing unit that may include a protective film removal region and a fifth transport region. The protective film removal region may be provided with a protective film removal unit that removes the protective film after the exposure processing by the exposure device and before the development processing by the development unit. The fifth transport region may be provided with a fifth transport unit that transports the substrate.

In this case, in the fifth processing unit, the protective film removal unit removes the protective film from the substrate after development processing and before exposure processing. The fifth transport unit transports the substrate before or after the removal of the protective film. This causes the development processing to be reliably performed in the second processing unit.

The processing section may further include a sixth processing unit that may have a pre-exposure cleaning region and a sixth transport region. The pre-exposure cleaning region may be provided with a pre-exposure cleaning unit that cleans the substrate before the exposure processing by the exposure device. The sixth transport region may be provided with a sixth transport unit that transports the substrate.

In this case, in the sixth processing unit, the pre-exposure cleaning unit cleans the substrate before exposure processing, and the sixth transport unit transports the substrate before or after the cleaning. This allows the clean substrate to be carried into the exposure device. Thus, contamination in the exposure device is prevented. Therefore, the substrate can be subjected to the exposure processing with high accuracy, which can sufficiently prevent processing defects in the substrate.

The pre-exposure cleaning unit may include a top surface and edge cleaning unit that cleans a top surface and an edge of the substrate before the exposure processing by the exposure device. In this case, the top surface and edge cleaning unit cleans the top surface and the edge of the substrate before the exposure processing, which prevents contamination in the exposure device due to a contaminant that adheres to the top surface and the edge of the substrate. Therefore, the substrate can be subjected to the exposure processing with high accuracy, which can sufficiently prevent processing defects in the substrate.

The sixth processing unit may further have a reversing region that may be provided with a reversing unit that reverses one surface and the other surface of the substrate. The pre-exposure cleaning unit may include a back surface cleaning unit that cleans a back surface of the substrate.

In this case, in the sixth processing unit, the reversing unit can reverse one surface and the other surface of the substrate before the exposure processing such that the back surface of the substrate whose top surface is directed upward is directed upward. The back surface cleaning unit cleans the back surface of the reverted substrate. This prevents contamination in the exposure device due to a contaminant that adheres to the back surface of the substrate. Therefore, the substrate can be subjected to the exposure processing with high accuracy, which can sufficiently prevent processing defects in the substrate.

The interface may include a cleaning/drying unit that cleans and dries the substrate after the exposure processing by the exposure device and an interface unit that transports the substrate. In this case, in the interface, the interface unit transports the substrate. Furthermore, the cleaning/drying unit subjects the substrate to cleaning processing before exposure processing. Even if dirt in an atmosphere adheres, after the exposure processing, to the substrate to which a liquid has adhered during the exposure processing, therefore, the attachment can removed.

Furthermore, the cleaning/drying unit subjects the substrate after the exposure processing to the drying processing, which can prevent the dirt in the atmosphere from adhering to the substrate after exposure processing.

Additionally, liquid that has adhered to the substrate during the exposure processing is prevented from dropping in the processing section, which can prevent operational problems such as abnormalities in an electric system of the substrate processing apparatus.

These results can sufficiently prevent processing defects in the substrate.

Other features, elements, characteristics, and advantages of the present invention will become more apparent from the following description of preferred embodiments of the present invention with reference to the attached drawings.

### BRIEF DESCRIPTION OF THE DRAWINGS

FIG. 1 is a plan view of a substrate processing apparatus according to a first embodiment;

FIG. 2 is a side view on one side of the substrate processing apparatus shown in FIG. 1;

FIG. 3 is a side view on the other side of the substrate processing apparatus shown in FIG. 1;

FIG. 4 is a diagram for explaining the configuration of a top surface and edge cleaning/drying unit;

FIG. 5 is a schematic view for explaining an edge of a substrate;

FIG. 6 is a diagram for explaining the configuration of an edge cleaning device in the top surface and edge cleaning/drying unit shown in FIG. 4;

FIG. 7 is a diagram for explaining another example of the configuration of the top surface and edge cleaning/drying unit;

FIG. 8 is a plan view of a substrate processing apparatus according to a second embodiment;

FIG. 9 is a side view on one side of the substrate processing apparatus shown in FIG. 8;

FIG. 10 is a side view on the other side of the substrate processing apparatus shown in FIG. 8;

FIG. 11 is a plan view of a substrate processing apparatus according to a third embodiment;

FIG. 12 is a side view on one side of the substrate processing apparatus shown in FIG. 11;

FIG. 13 is a side view on the other side of the substrate processing apparatus shown in FIG. 11;

FIG. 14 is a diagram for explaining the configuration of a back surface cleaning unit;

FIG. 15 is a perspective view showing the appearance of a substrate reversing device provided in a reversing unit;

FIG. 16 is a perspective view showing the appearance of a part of the substrate reversing device;

FIG. 17 is a schematic view showing the operations of the substrate reversing device shown in FIG. 15; and

FIG. 18 is a schematic view showing the operations of the substrate reversing device shown in FIG. 15.

### DETAILED DESCRIPTION OF SPECIFIC EMBODIMENTS

A substrate processing apparatus according to an embodiment of the present invention will be described with reference to the drawings. In the following description, a substrate refers to a semiconductor substrate, a substrate for a liquid crystal display, a substrate for a plasma display, a glass substrate for a photomask, a substrate for an optical disk, a substrate for a magnetic disk, a substrate for a magneto-optical disk, a substrate for a photomask, or the like.

In the following description, a surface, on which various patterns such as a circuit pattern are formed, of the substrate is referred to as a top surface, and a surface on the opposite side thereto is referred to as a back surface. Furthermore, a surface, directed downward, of the substrate is referred to as a lower surface, and a surface, directed upward, of the substrate is referred to as an upper surface.

Furthermore, the following drawings are accompanied by arrows that respectively indicate X, Y, and Z directions perpendicular to one another for clarity of a positional relationship. The X and Y directions are perpendicular to each other within a horizontal plane, and the Z direction corresponds to a vertical direction. In each of the directions, the direction of the arrow is defined as a + (positive) direction, and the opposite direction is defined as a − (negative) direction. A rotation direction centered around the Z direction is defined as a θ direction.

A substrate processing apparatus according to a first embodiment of the present invention will be now described with reference to the drawings.

(1) Configuration of Substrate Processing Apparatus

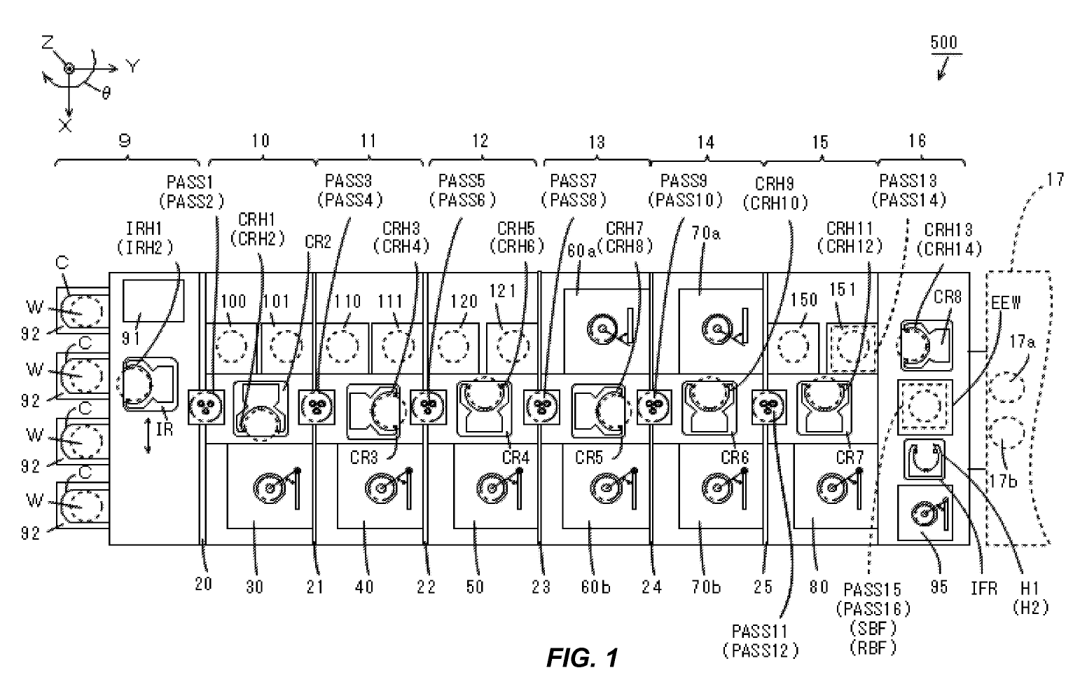

FIG. 1 is a plan view of a substrate processing apparatus 500 according to the first embodiment. As shown in FIG. 1, the substrate processing apparatus 500 includes an indexer block 9, an anti-reflection film processing block 10, a resist film processing block 11, a resist cover film processing block 12, a development processing block 13, a resist cover film removal block 14, a cleaning/drying processing block 15, and an interface block 16. In the substrate processing apparatus 500, the blocks are provided side by side in the foregoing order.

An exposure device 17 is arranged adjacent to the interface block 16 in the substrate processing apparatus 500. The exposure device 17 subjects a substrate W to exposure processing by means of a liquid immersion method.

The indexer block 9 includes a main controller (controller) 91 for controlling the operation of each of the blocks, a plurality of carrier platforms 92, and an indexer robot IR. The indexer robot IR has hands IRH1 and IRH2 provided one above the other for receiving and transferring the substrates W.

The anti-reflection film processing block 10 includes thermal processing groups 100 and 101 for anti-reflection film, a coating processing group 30 for anti-reflection film, and a second central robot CR2. The coating processing group 30 is provided opposite to the thermal processing groups 100 and 101 with the second central robot CR2 interposed therebetween. The second central robot CR2 has hands CRH1 and CRH2 provided one above the other for receiving and transferring the substrates W.

A partition wall 20 is provided between the indexer block 9 and the anti-reflection film processing block 10 for shielding an atmosphere. The partition wall 20 has substrate platforms PASS1 and PASS2 provided in close proximity one above the other for receiving and transferring the substrates W between the indexer block 9 and the anti-reflection film processing block 10. The upper substrate platform PASS1 is used in transporting the substrates W from the indexer block 9 to the anti-reflection film processing block 10, and the lower substrate platform PASS2 is used in transporting the substrates W from the anti-reflection film processing block 10 to the indexer block 9.

Each of the substrate platforms PASS1 and PASS2 is provided with an optical sensor (not shown) for detecting the presence or absence of the substrate W. This allows determination to be made whether or not the substrate W is placed on the substrate platform PASS1 or PASS2. In addition, each of the substrate platforms PASS1 and PASS2 has a plurality of support pins secured thereto. Note that each of substrate platforms PASS3 to PASS16 described later is similarly provided with an optical sensor and support pins.

The resist film processing block 11 includes thermal processing groups 110 and 111 for resist film, a coating processing group 40 for resist film, and a third central robot CR3. The coating processing group 40 is provided opposite to the thermal processing groups 110 and 111 with the third central robot CR3 interposed therebetween. The third central robot CR3 has hands CRH3 and CRH4 provided one above the other for receiving and transferring the substrates W.

A partition wall 21 is provided between the anti-reflection film processing block 10 and the resist film processing block 11 for shielding an atmosphere. The partition wall 21 has substrate platforms PASS3 and PASS4 provided in close proximity one above the other for receiving and transferring the substrates W between the anti-reflection film processing block 10 and the resist film processing block 11. The upper substrate platform PASS3 is used in transporting the substrates W from the anti-reflection film processing block 10 to the resist film processing block 11, and the lower substrate platform PASS4 is used in transporting the substrates W from the resist film processing block 11 to the anti-reflection film processing block 10.

The resist cover film processing block 12 includes thermal processing groups 120 and 121 for resist cover film, a coating processing group 50 for resist cover film, and a fourth central robot CR4. The coating processing group 50 is provided opposite to the thermal processing groups 120 and 121 with the fourth central robot CR4 interposed therebetween. The fourth central robot CR4 has hands CRH5 and CRH6 provided one above the other for receiving and transferring the substrates W.

A partition wall 22 is provided between the resist film processing block 11 and the resist cover film processing block 12 for shielding an atmosphere. The partition wall 22 has substrate platforms PASS5 and PASS6 provided in close proximity one above the other for receiving and transferring the substrates W between the resist film processing block 11 and the resist cover film processing block 12. The upper substrate platform PASS5 is used in transporting the substrates W from the resist film processing block 11 to the resist cover film processing block 12, and the lower substrate platform PASS6 is used in transporting the substrates W from the resist cover film processing block 12 to the resist film processing block 11.

The development processing block 13 includes development processing groups 60a and 60b and a fifth central robot CR5. The development processing groups 60a and 60b are provided opposite to each other with the fifth central robot CR5 interposed therebetween. The fifth central robot CR5 has hands CRH7 and CRH8 provided one above the other for receiving and transferring the substrates W.

A partition wall 23 is provided between the resist cover film processing block 12 and the development processing block 13 for shielding an atmosphere. The partition wall 23 has substrate platforms PASS7 and PASS8 provided in close proximity one above the other for receiving and transferring the substrates W between the resist cover film processing block 12 and the development processing block 13. The upper substrate platform PASS7 is used in transporting the substrates W from the resist cover film processing block 12 to the development processing block 13, and the lower substrate platform PASS8 is used in transporting the substrates W from the development processing block 13 to the resist cover film processing block 12.

The resist cover film removal block 14 includes removal processing groups 70a and 70b for resist cover film and a sixth central robot CR6. The removal processing groups 70a and 70b are provided opposite to each other with the sixth central robot CR6 interposed therebetween. The sixth central robot CR6 has hands CRH9 and CRH10 provided one above the other for receiving and transferring the substrates W.

A partition wall 24 is provided between the development processing block 13 and the resist cover film removal block 14 for shielding an atmosphere. The partition wall 24 has substrate platforms PASS9 and PASS10 provided in close proximity one above the other for receiving and transferring the substrates W between the development processing block 13 and the resist cover film removal block 14. The upper substrate platform PASS9 is used in transporting the substrates W from the development processing block 13 to the resist cover film removal block 14, and the lower substrate platform PASS10 is used in transporting the substrates W from the resist cover film removal block 14 to the development processing block 13.

The cleaning/drying processing block 15 includes thermal processing groups 150 and 151 for post-exposure bake, a cleaning/drying processing group 80, and a seventh central robot CR7. The thermal processing group 151 is adjacent to the interface block 16, and includes substrate platforms PASS13 and PASS14, as described later. The cleaning/drying processing group 80 is provided opposite to the thermal processing groups 150 and 151 with the seventh central robot CR7 interposed therebetween. The seventh central robot CR7 has hands CRH11 and CRH12 provided one above the other for receiving and transferring the substrates W.

A partition wall 25 is provided between the resist cover film removal block 14 and the cleaning/drying processing block 15 for shielding an atmosphere. The partition wall 25 has substrate platforms PASS11 and PASS12 provided in close proximity one above the other for receiving and transferring the substrates W between the resist cover film removal block 14 and the cleaning/drying processing block 15. The upper substrate platform PASS11 is used in transporting the substrates W from the resist cover film removal block 14 to the cleaning/drying processing block 15, and the lower substrate platform PASS12 is used in transporting the substrates W from the cleaning/drying processing block 15 to the resist cover film removal block 14.

In the interface block 16, an eighth center robot CR8, an edge exposure unit EEW, an interface transporting mechanism IFR, and a post-exposure cleaning/drying processing group 95 are arranged in this order along the +X direction. Substrate platforms PASS15 and PASS16, a sending buffer 16, and a return buffer RBF, described later, are provided below the edge exposure unit 95. The eighth central robot CR8 has hands CRH13 and CRH14 provided one above the other for receiving and transferring the substrates W, and the interface transporting mechanism IFR has hands H1 and H2 provided one above the other for receiving and transferring the substrates W.

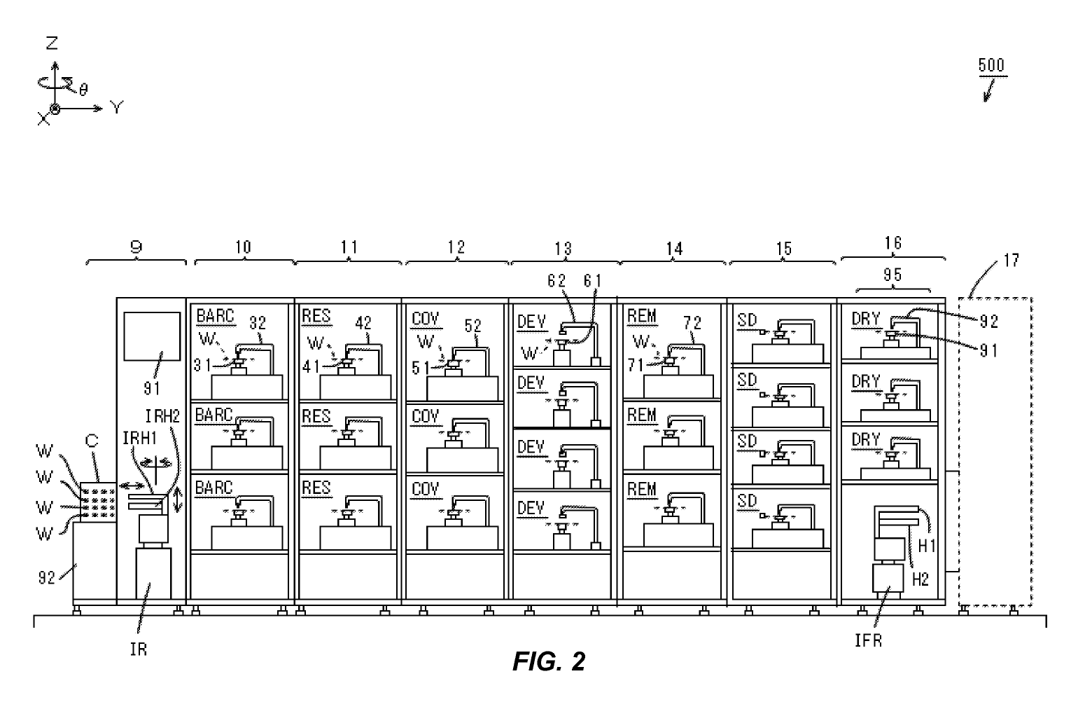

FIG. 2 is a side view on one side of the substrate processing apparatus 500 shown in FIG. 1. The coating processing group 30 (see FIG. 1) in the anti-reflection film processing block 10 has a vertical stack of three coating units BARC. Each of the coating units BARC includes a spin chuck 31 for rotating the substrate W with the substrate W held in a horizontal attitude by suction, and a supply nozzle 32 for supplying a coating liquid for an anti-reflection film to the substrate W held on the spin chuck 31.

The coating processing group 40 (see FIG. 1) in the resist film processing block 11 has a vertical stack of three coating units RES. Each of the coating units RES includes a spin chuck 41 for rotating the substrate W with the substrate W held in a horizontal attitude by suction, and a supply nozzle 42 for supplying a coating liquid for a resist film to the substrate W held on the spin chuck 41.

The coating processing group 50 (see FIG. 1) in the resist cover film processing block 12 has a vertical stack of three coating units COV. Each of the coating units COV includes a spin chuck 61 for rotating the substrate W with the substrate W held in a horizontal attitude by suction, and a supply nozzle 52 for supplying a coating liquid for a resist cover film to the substrate W held on the spin chuck 51. Materials having a low affinity for resists and water (materials having low reactivity to resists and water) can be used as the coating liquid for the resist cover film. An example of the coating liquid is fluororesin. Each of the coating units COV forms a resist cover film on the resist film formed on the substrate W by applying the coating liquid onto the substrate W while rotating the substrate W.

The development processing group 60b (see FIG. 1) in the development processing block 13 has a vertical stack of four development processing units DEV. Each of the development processing units DEV includes a spin chuck 61 for rotating the substrate W with the substrate W held in a horizontal attitude by suction, and a supply nozzle 62 for supplying a development liquid to the substrate W held on the spin chuck 51.

The removal processing group 70b (see FIG. 1) in the resist cover film removal block 14 has a vertical stack of three removal units REM. Each of the removal units REM includes a spin chuck 71 for rotating the substrate W with the substrate W held in a horizontal attitude by suction, and a supply nozzle 72 for supplying a stripping liquid (e.g. fluororesin) to the substrate W held on the spin chuck 71. Each of the removal units REM removes the resist cover film formed on the substrate W by applying the stripping liquid onto the substrate W while rotating the substrate W.

Note that a method of removing the resist cover film in the removal units REM is not limited to the above-mentioned example. For example, the resist cover film may be removed by supplying the stripping liquid onto the substrate W while moving a slit nozzle above the substrate W.

The cleaning/drying processing group 80 (see FIG. 1) in the cleaning/drying processing block 15 has a vertical stack of four top surface and edge cleaning/drying units SD. The details of the top surface and edge cleaning/drying unit SD will be described later.

The post-exposure cleaning/drying processing group 95 in the interface block 16 has a vertical stack of three post-exposure cleaning/drying units DRY. Each of the post-exposure cleaning/drying units DRY includes a spin chuck 91 for rotating the substrate W with the substrate W held in a horizontal attitude by suction, and a nozzle 92 for supplying a processing liquid for cleaning (a cleaning liquid and a rinse liquid) to the substrate W held on the spin chuck 91.

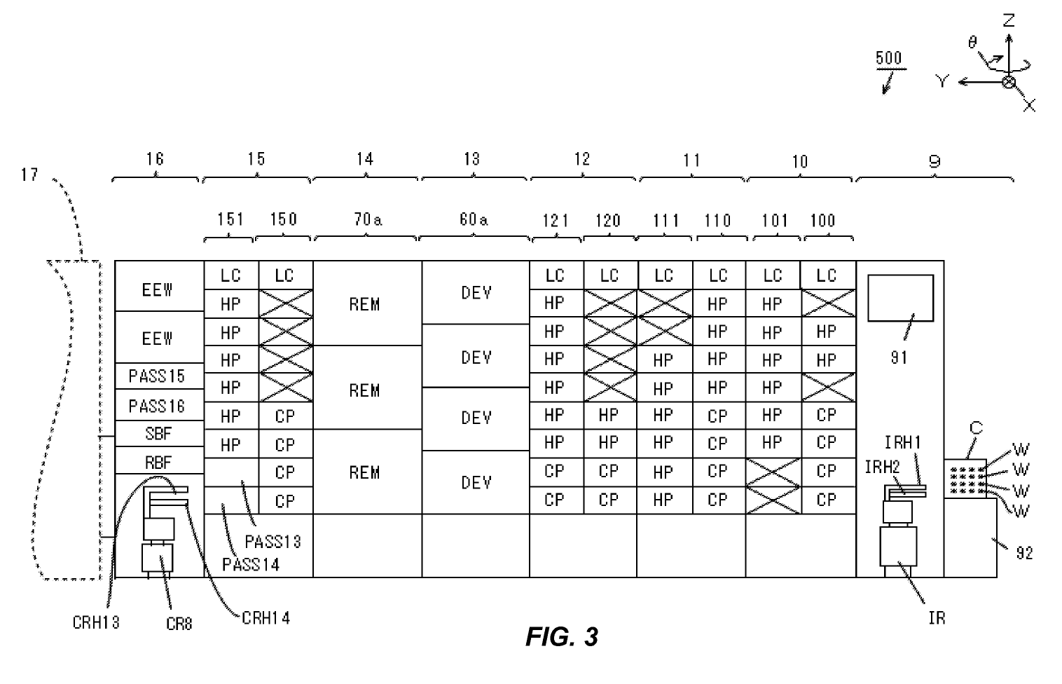

FIG. 3 is a side view on the other side of the substrate processing apparatus 500 shown in FIG. 1. In the anti-reflection film processing block 10, the thermal processing group 100 has a vertical stack of two heating units (hot plates) HP and four cooling units (cooling plates) CP, and the thermal processing group 101 has a vertical stack of six heating units HP. Furthermore, each of the thermal processing groups 100 and 101 has a local controller LC for controlling the respective temperatures of the heating unit HP and the cooling unit CP arranged in its uppermost part.

In the resist film processing block 11, the thermal processing group 110 has a vertical stack of four heating units HP and four cooling units CP, and the thermal processing group 111 has a vertical stack of six heating units HP. Furthermore, each of the thermal processing groups 110 and 111 also has a local controller LC for controlling the respective temperatures of the heating unit HP and the cooling unit CP arranged in its uppermost part.

In the resist cover film processing block 12, the thermal processing group 120 has a vertical stack of two heating units HP and two cooling units CP, and the thermal processing group 121 has a vertical stack of six heating units HP and two cooling units CP. Furthermore, each of the thermal processing groups 120 and 121 has a local controller LC for controlling the respective temperatures of the heating unit HP and the cooling unit CP arranged in its uppermost part.

The development processing group 60a in the development processing block 13 has a vertical stack of four development processing units DEV. The removal processing group 70a in the resist cover film removal block 14 has a vertical stack of three removal units REM.

In the cleaning/drying processing block 15, the thermal processing group 150 has a vertical stack of four cooling units CP, and the thermal processing group 151 has a vertical stack of six heating units HP and substrate platforms PASS13 and PASS14. Furthermore, each of the thermal processing groups 150 and 151 has a local controller LC for controlling the respective temperatures of the heating unit HP and the cooling unit CP arranged in its uppermost part.

The interface block 16 has a vertical stack of two edge exposure units EEW, substrate platforms PASS15 and PASS16, a sending buffer unit SBF, and a return buffer unit RBF arranged in its substantially central part (see FIG. 1). Each of the edge exposure units EEW includes a spin chuck (not shown) for rotating the substrate W with the substrate W held in a horizontal attitude by suction, and a light irradiator (not shown) for exposing a peripheral portion of the substrate W held on the spin chuck.

Note that the respective numbers of coating units BARC, RES, and COV, top surface and edge cleaning/drying units SD, removal units REM, post-exposure cleaning/drying units DRY, edge exposure units EEW, heating units HP, and cooling units CP may be changed, as needed, depending on the processing speed of each of the blocks 10 to 16.

Operations of the Substrate Processing Apparatus

The operations of the substrate processing apparatus 500 according to the first embodiment will be then described with reference to FIGS. 1 to 3. Carriers C that each store a plurality of substrates W in multiple stages are respectively placed on the carrier platforms 92 in the indexer block 9. The indexer robot IR takes out the unprocessed substrate W that is stored in the carrier C using the upper hand IRH1. Thereafter, the indexer robot IR rotates in the ±θ direction while moving in the ±X direction, to place the unprocessed substrate W on the substrate platform PASS1.

Although FOUPs (Front Opening Unified Pods) are adopted as the carriers C in the present embodiment, the present invention is not limited to the same. For example, SMIF (Standard Mechanical Inter Face) pods, or OCs (Open Cassettes) that expose the stored substrates W to outside air may be used.

Furthermore, although linear-type transport robots that move their hands forward or backward by linearly sliding them to the substrate W are respectively used as the indexer robot IR, the second to eighth central robots CR2 to CR8, and the interface transporting mechanism IFR, the present invention is not limited to the same. For example, multi-joint type transport robots that linearly move their hands forward and backward by moving their joints may be used.

The substrate W placed on the substrate platform PASS1 is received by the second central robot CR2 in the anti-reflection film processing block 10. The second central robot CR2 carries the substrate W into the coating processing group 30. In the coating processing group 30, the coating unit BARC forms a coating of an anti-reflection film on the substrate W in order to reduce standing waves and halation generated during the exposure processing.

Thereafter, the second central robot CR2 then takes out the substrate W that has been subjected to coating processing from the coating processing group 30, and carries the substrate W into the thermal processing group 100 or 101. Then, the second central robot CR2 takes out the thermally processed substrate W from the thermal processing group 100 or 101, and places the substrate W on the substrate platform PASS3.

The substrate W placed on the substrate platform PASS3 is received by the third central robot CR3 in the resist film processing block 11. The third central robot CR3 carries the substrate W into the coating processing group 40. In the coating processing group 40, the coating unit RES forms a coating of a resist film on the anti-reflection film. Thereafter, the third central robot CR3 takes out the substrate W that has been subjected to coating processing from the coating processing group 40, and carries the substrate W into the thermal processing group 110 or 111. Then, the third central robot CR3 takes out the thermally processed substrate W from the thermal processing group 110 or 111, and places the substrate W on the substrate platform PASS5.

The substrate W placed on the substrate platform PASS5 is received by the fourth central robot CR4 in the resist cover film processing block 12. The fourth central robot CR4 carries the substrate W into the coating processing group 50. In the coating processing group 50, the coating unit COV forms a coating of a resist cover film on the resist film. Thereafter, the fourth central robot CR4 takes out the substrate W that has been subjected to the coating processing from the coating processing group 50, and carries the substrate W into the thermal processing group 120. Then, the fourth central robot CR4 takes out the thermally processed substrate W from the thermal processing group 120, and places the substrate W on the substrate platform PASS7.

The substrate W placed on the substrate platform PASS7 is received by the fifth central robot CR5 in the development processing block 13. The fifth central robot CR5 places the substrate W on the substrate platform PASS9. The substrate W placed on the substrate platform PASS9 is received by the sixth central robot CR6 in the resist cover film removal block 14. The sixth central robot CR6 places the substrate W on the substrate platform PASS11. The substrate W placed on the substrate platform PASS11 is received by the seventh central robot CR7 in the cleaning/drying processing block 15.

The seventh central robot CR7 carries the substrate W into the top surface and edge cleaning/drying unit SD in the cleaning/drying processing group 80. The top surface and edge cleaning/drying processing unit SD subjects the substrate W that has been carried thereinto to top surface and edge cleaning processing, described later. This causes a top surface and an edge of the substrate W before exposure processing by the exposure device 17 to be kept clean.

Then, the seventh central robot CR7 takes out the substrate W that has been subjected to the top surface and edge cleaning processing from the top surface and edge cleaning/drying unit SD, and places the substrate W on the substrate platform PASS13. The substrate W placed on the substrate platform PASS13 is received by the eighth central robot CR8 in the interface block 16. The eighth central robot CR8 carries the substrate W into the edge exposure unit EEW. The edge exposure unit EEW subjects the peripheral portion of the substrate W to edge exposure processing. Then, the eighth central robot CR8 takes out the substrate W that has been subjected to the edge exposure processing from the edge exposure unit EEW, and places the substrate W on the substrate platform PASS15.

The substrate W placed on the substrate platform PASS15 is carried into a substrate carry-in section 17a (see FIG. 1) in the exposure device 17 by the interface transporting mechanism IFR. Note that when the exposure device 17 cannot receive the substrate W, the substrate W is temporarily stored in the sending buffer unit SBF. After the exposure device 17 subjects the substrate W to exposure processing, the interface transporting mechanism IFR takes out the substrate W from a substrate carry-out section 17b (see FIG. 1) in the exposure device 17, and carries the substrate W into the post-exposure cleaning/drying processing group 95.

As described in the foregoing, in the post-exposure cleaning/drying unit DRY in the post-exposure cleaning/drying processing group 95, a processing liquid (a cleaning liquid and a rinse liquid) is supplied from the nozzle 92 to the top surface of the substrate W that rotates in a horizontal attitude by the spin chuck 91 (see FIG. 2). This causes the top surface of the substrate W to be cleaned. Thereafter, the supply of the processing liquid from the nozzle 92 to the substrate W is stopped, which causes the cleaning liquid that adheres to the substrate W to be scattered while causing the top surface of the substrate W to be dried (scattering drying).

Note that the post-exposure cleaning/drying unit DRY may be provided with a gas spray nozzle that sprays inert gas on the top surface of the substrate W. In this case, the inert gas is sprayed on the substrate W from the gas spray nozzle while the substrate W is being subjected to the scattering drying or after a liquid layer of the rinse liquid is formed on the top surface of the substrate W, which causes the top surface of the substrate W to be reliably dried.

In the post-exposure cleaning/drying processing group 95, The substrate W after the exposure processing is thus subjected to the cleaning and drying processing. Thereafter, the interface transporting mechanism IFR takes out the substrate W from the post-exposure cleaning/drying processing group 95, and places the substrate W on the substrate platform PASS16. When the cleaning and drying processing cannot be temporarily performed in the post-exposure cleaning/drying processing group 95 due to a failure or the like, the substrate W after the exposure processing can be temporarily stored in the return buffer unit RBF in the interface block 16.

The substrate W placed on the substrate platform PASS16 is received by the eighth central robot CR8 in the interface block 16. The eighth central robot CR8 carries the substrate W into the thermal processing group 151 in the cleaning/drying processing block 15. In the thermal processing group 151, the substrate W is subjected to post-exposure bake (PEB). Thereafter, the eighth central robot CR8 takes out the substrate W from the thermal processing group 151, and places the substrate W on the substrate platform PASS14. Although the thermal processing group 151 subjects the substrate W to the post-exposure bake in the present embodiment, the thermal processing group 150 may subject the substrate W to post-exposure bake.

The substrate W placed on the substrate platform PASS14 is received by the seventh central robot CR7 in the cleaning/drying processing block 15. The seventh central robot CR7 places the substrate W on the substrate platform PASS12. The substrate W placed on the substrate platform PASS12 is received by the sixth central robot CR6 in the resist cover film removal block 14. The sixth central robot CR6 carries the substrate W into the resist cover film removal processing group 70a or 70b. In the resist cover film removal processing group 70a or 70b, the removal unit REM removes the resist cover film on the substrate W. Thereafter, the sixth central robot CR6 takes out the substrate W that has been subjected to the removal processing from the resist cover film removal processing group 70a or 70b, and places the substrate W on the substrate platform PASS10.

The substrate W placed on the substrate platform PASS10 is received by the fifth central robot CR5 in the development processing block 13. The fifth central robot CR5 carries the substrate W into the development processing group 60a or 60b. In the development processing group 60a or 60b, the development processing unit DEW subjects the substrate W to development processing. Thereafter, the fifth central robot CR5 takes out the substrate W that has been subjected to the development processing from the development processing group 60a or 60b, and places the substrate W on the substrate platform PASS8.

The substrate W placed on the substrate platform PASS8 is received by the fourth central robot CR4 in the resist cover film processing block 12. The fourth center robot CR4 carries the substrate W into the thermal processing group 121. In the thermal processing group 121, the substrate W after the development processing is subjected to thermal processing.

The fourth central robot CR4 takes out the thermally processed substrate W from the thermal processing group 121, and places the substrate W on the substrate platform PASS6. The substrate W placed on the substrate platform PASS6 is received by the third central robot CR3 in the resist film processing block 11. The third central robot CR3 places the substrate W on the substrate platform PASS4. The substrate W placed on the substrate platform PASS4 is received by the second central robot CR2 in the anti-reflection film processing block 10. The second central robot CR2 places the substrate W on the substrate platform PASS2. The substrate W placed on the substrate platform PASS2 is stored in the carrier C by the indexer robot IR in the indexer block 9.

As to the Top Surface and Edge Cleaning/Drying Unit

The top surface and edge cleaning/drying unit SD will be herein described in detail with reference to the drawings. Note that the operation of each of constituent elements in the top surface and edge cleaning/drying unit SD, described below, is controlled by the main controller (controller) 91 shown in FIG. 1.

Configuration of the Top Surface and Edge Cleaning/Drying Unit

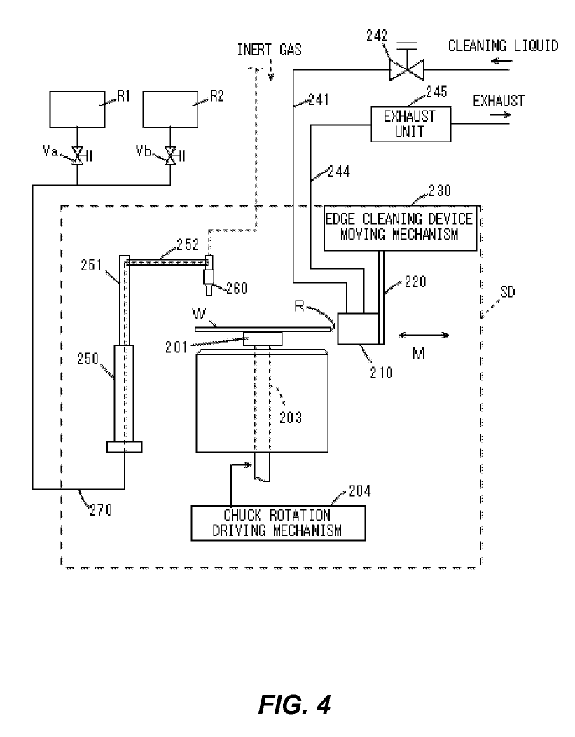

FIG. 4 is a diagram for explaining the configuration of the top surface and edge cleaning/drying unit SD. In the top surface and edge cleaning/drying unit SD, the top surface and the edge of the substrate W are cleaned (top surface and edge cleaning processing). As shown in FIG. 4, the top surface and edge cleaning/drying unit SD includes a spin chuck 201 for rotating the substrate W about a vertical rotation axis passing through the center of the substrate W while horizontally holding the substrate W.

The spin chuck 201 is secured to an upper end of a rotation shaft 203 that is rotated by a chuck rotation driving mechanism 204. A suction path (not shown) is formed in the spin chuck 201. Air inside the suction path is exhausted with the substrate W placed on the spin chuck 201, to attract a lower surface of the substrate W to the spin chuck 201 under vacuum, so that the substrate W can be held in a horizontal attitude. A motor 250 is provided beside the spin chuck 201. A rotation shaft 251 is connected to the motor 250. An arm 252 is connected to the rotation shaft 251 so as to extend in the horizontal direction, and its tip is provided with a top surface cleaning nozzle 260. The motor 250 causes the rotation shaft 251 to rotate while causing the arm 252 to swing. This allows the top surface cleaning nozzle 260 to move between an upper position and an outer position of the substrate W held by the spin chuck 201.

A supply pipe 270 for cleaning processing is provided so as to pass through the motor 250, the rotation shaft 251, and the arm 252. The supply pipe 270 is connected to a cleaning liquid supply source R1 and a rinse liquid supply source R2 through a valve Va and a valve Vb, respectively. By controlling the opening and closing of the valves Va and Vb, it is possible to select a processing liquid supplied to the supply pipe 270 and adjust the supply amount thereof. In the configuration shown in FIG. 4, a cleaning liquid can be supplied to the supply pipe 270 by opening the valve Va, and a rinse liquid can be supplied to the supply pipe 270 by opening the valve Vb.

By thus controlling the opening and closing of the valves Va and Vb, it is possible to supply the cleaning liquid or the rinse liquid to the top surface of the substrate W through the supply pipe 270 and the top surface cleaning nozzle 260. This allows the top surface of the substrate W to be cleaned. An example of the cleaning liquid is any one of a predetermined resist solvent, a fluorine-based medical liquid, an ammonia/hydrogen peroxide mixture, and a liquid used for the liquid immersion method in the exposure device 17. Another example of the cleaning liquid can be also any one of pure water, a pure water solution containing a complex (ionized), carbonic water, hydrogen water, electrolytic ionic water, HFE (hydrofluoroether), hydrofluoric acid, sulfuric acid, and a sulfuric acid/hydrogen peroxide mixture. An example of the rinse liquid is any one of pure water, carbonated water, hydrogen water, electrolytic ionic water, and HFE.

Furthermore, an edge cleaning device moving mechanism 230 is provided beside the spin chuck 201 and in an upper part of the top surface and edge cleaning/drying unit SD. A stick-shaped supporting member 220 extending downward is attached to the edge cleaning device moving mechanism 230. The supporting member 220 moves in the vertical direction and the horizontal direction by the edge cleaning device moving mechanism 230.

An edge cleaning device 210 having a substantially cylindrical shape is attached to a lower end of the supporting member 220 so as to extend in the horizontal direction. This causes the edge cleaning device 210, together with the supporting member 220, to move by the edge cleaning device moving mechanism 230. This allows one end of the edge cleaning device 210 to be opposite to the edge R of the substrate W held in the spin chuck 201. In the following description, the one end, which is opposite to the edge R of the substrate W, of the edge cleaning device 210 is taken as a front surface.

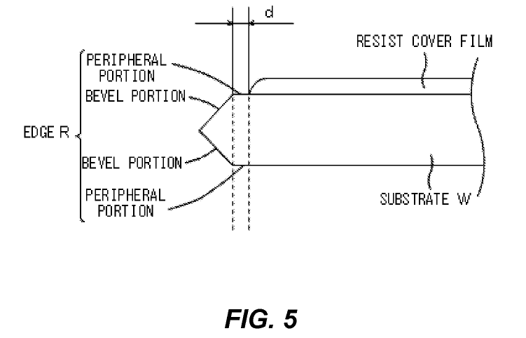

The definition of the edge R of the substrate W will be herein described while referring to the following drawings. FIG. 5 is a schematic view for explaining the edge R of the substrate W. As shown in FIG. 5, an anti-reflection film and a resist film (both are not illustrated) and a resist cover film, described above, are formed on the substrate W.

The substrate W has an end surface. The end surface is as schematically illustrated in FIG. 5. The end surface is generally referred to as a bevel portion. A region inwardly spaced a distance d apart from an end of the top surface of the substrate W on which the resist cover film is formed is generally referred to as a peripheral portion. In the present embodiment, the bevel portion and the peripheral portion are generically referred to as an edge R. Note that the distance d is 2 to 3 mm, for example. Furthermore, the edge R need not include the peripheral portion. In this case, the top surface and edge cleaning/drying unit SD cleans only the bevel portion at the edge R of the substrate W. Generally, the resist cover film may not be formed so as to cover the peripheral portion on the substrate W in many cases. That is, one or both of the anti-reflection film and the resist film formed in the peripheral portion on the substrate W is/are exposed.

Returning to FIG. 4, the edge cleaning device 210 moves to a position in the vicinity of the edge R of the substrate W on the spin chuck 201 by the edge cleaning device moving mechanism 230 during the top surface and edge cleaning processing, while waiting outside the spin chuck 201 in a time period during which the top surface and edge cleaning processing is not performed.

The edge cleaning device 210 has a space in its inner part (a cleaning chamber 211, described later). A cleaning liquid supply pipe 241 and an exhaust pipe 244 are connected to the edge cleaning device 210. The cleaning liquid supply pipe 241 is connected to a cleaning liquid supply system (not shown) through a valve 242. By opening the valve 242, the cleaning liquid is supplied to the inner space of the edge cleaning device 210 through the cleaning liquid supply pipe 241. Furthermore, the exhaust pipe 244 is connected to an exhaust unit 245. The exhaust unit 245 sucks in an atmosphere in the inner space of the edge cleaning device 210, and exhausts the air through the exhaust pipe 244.

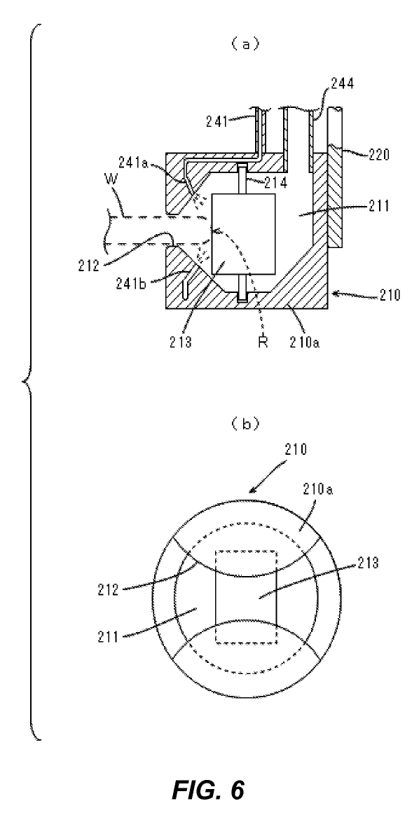

The details of the edge cleaning device 210 will be herein described. FIG. 6 is a diagram for explaining the configuration of the edge cleaning device 210 in the top surface and edge cleaning/drying unit SD shown in FIG. 4. FIG. 6(a) is a vertical sectional view of the edge cleaning device 210, and FIG. 6(b) is a front view of the edge cleaning device 210. As shown in FIG. 6(a), a cleaning chamber 211 is formed inside a substantially cylindrical housing 210a in the edge cleaning device 210.

Furthermore, as shown in FIGS. 6(a) and 6(b), an opening 212 for causing the cleaning chamber 211 and the outside of the housing 210a to communicate with each other is formed on the side of a front surface of the housing 210a. The opening 212 has an upper surface and a lower surface in a circular arc shape such that the vertical width thereof is gradually enlarged sideward on both sides from the center thereof. During the top surface and edge cleaning processing of the substrate W, the edge R of the substrate W held by suction on the spin chuck 201 is inserted into the opening 212.

A brush 213 having a substantially cylindrical shape is arranged so as to extend in the vertical direction within the cleaning chamber 211. The brush 213 is attached to a rotation shaft 214 extending in the vertical direction. An upper end and a lower end of the rotation shaft 214 are respectively attached to rotation bearings formed at the top and the bottom of the cleaning chamber 211. This causes the brush 213 to be rotatably supported by the cleaning chamber 211 and the rotation shaft 214. During the top surface and edge cleaning processing of the substrate W, the edge R of the rotating substrate W and the brush 213 come into contact with each other. This causes the edge R of the substrate W to be cleaned with the brush 213.

Here, in the top surface and edge cleaning/drying unit SD shown in FIG. 4, the rotation shaft 214 having the brush 213 attached thereto is arranged so as to be substantially parallel to the rotation shaft 203 having the spin chuck 201 secured thereto. This causes the brush 213 to rotate with the brush 213 brought into reliable contact with the edge R of the rotating substrate W. The cleaning liquid supply pipe 241 and the exhaust pipe 244, described above, are connected to the top of the edge cleaning device 210.

The cleaning liquid supply pipe 241 is connected to cleaning liquid supply paths 241a and 241b formed within the housing 210a. As shown in FIG. 6(a), the cleaning liquid supply path 241a extends to an inner surface in an upper part of the cleaning chamber 211 from the outside of the housing 210a. The cleaning liquid supply path 241b extends to an inner surface in a lower part of the cleaning chamber 211 from the outside of the housing 210a. FIG. 6(a) illustrates only a part of the cleaning liquid supply pipe 241b.

Such a configuration causes the cleaning liquid supplied to the edge cleaning device 210 to be sprayed in the vertical direction toward the edge R of the substrate W that comes into contact with the brush 213 within the cleaning chamber 211 during the top surface and edge cleaning processing of the substrate W. This causes the edge R of the substrate W to be efficiently cleaned.

The exhaust pipe 244 is inserted into the cleaning chamber 211 through a hole provided at the top of the housing 210a. This causes an atmosphere in the cleaning chamber 211 to be sucked in by the exhaust unit 245 shown in FIG. 4 and exhausted through the exhaust pipe 244, as described above. In the cleaning chamber 211, the exhaust unit 245 thus exhausts the atmosphere inside thereof, so that the volatilized cleaning liquid and a mist of the cleaning liquid are efficiently exhausted.

In the foregoing, an example of the cleaning liquid sprayed on the edge R of the substrate W is any one of a predetermined resist solvent, a fluorine-based medical liquid, an ammonia/hydrogen peroxide mixture, and a liquid used for the liquid immersion method in the exposure device 17. Another example of the cleaning liquid can be also any one of pure water, a pure water solution containing a complex (ionized), carbonic water, hydrogen water, electrolytic ionic water, HFE (hydrofluoroether), hydrofluoric acid, sulfuric acid, and a sulfuric acid/hydrogen peroxide mixture, similarly to the example of the cleaning liquid for cleaning the top surface of the substrate W.

When the edge R of the substrate W is cleaned with the brush 213, as described above, the brush 213 is brought into direct contact with the edge R of the substrate W, so that a contaminant at the edge R of the substrate W can be physically stripped. This allows the contaminant that has firmly adhered to the edge R to be more reliably removed.

Operations of the Top Surface and Edge Cleaning/Drying Unit

The processing operations of the top surface and edge cleaning/drying processing unit SD having the above-mentioned configuration will be described. When the substrate W is carried into the top surface and edge cleaning/drying unit SD, the seventh central robot CR7 shown in FIG. 1 places the substrate W on the spin chuck 201. The substrate W placed on the spin chuck 201 is held by suction on the spin chuck 201. Then, the top surface cleaning nozzle 260 moves to above the center of the substrate W while the edge cleaning device 210 moves to a position in the vicinity of the edge R of the substrate W on the spin chuck 201. The rotation shaft 203 rotates so that the substrate W rotates.

In this state, the cleaning liquid is discharged to the top surface of the substrate W from the top surface cleaning nozzle 260. This causes the top surface of the substrate W to be cleaned. At the same time, the cleaning liquid is supplied to the edge cleaning device 210. This causes the edge R of the substrate W to be cleaned. After an elapse of a predetermined time period, the top surface cleaning nozzle 260 discharges the rinse liquid to the top surface of the substrate W in place of the cleaning liquid. This causes the cleaning liquid supplied onto the substrate W to be cleaned away. At this time, the supply of the cleaning liquid to the edge cleaning device 210 is stopped. Thus, the rinse liquid discharged to the top surface of the substrate W flows into the edge R of the substrate W, so that the cleaning liquid that adheres to the edge R of the substrate W is cleaned away.

Furthermore, after an elapse of a predetermined time period, the top surface cleaning nozzle 260 stops to discharge the rinse liquid to the substrate W, to move outward apart from the substrate W held by the spin chuck 201. The edge cleaning device 210 also moves outward apart from the substrate W. The number of revolutions of the rotation shaft 203 increases. This causes a great centrifugal force to act on the rinse liquid remaining on the substrate W. Thus, the liquid that adheres to the top surface and the edge R of the substrate W is scattered, so that the substrate W is dried.

Note that in the cleaning/drying processing group 80, a component of the resist cover film on the substrate W is eluted in the cleaning liquid during the above-mentioned top surface and edge cleaning processing. This can prevent the component of the resist cover film that has been eluted in the cleaning liquid from remaining on the substrate W. Note that the component of the resist cover film may be eluted in pure water with the pure water poured onto the substrate W and held thereon for a certain time period, for example.

The cleaning liquid and the rinse liquid may be supplied onto the substrate W by means of a soft spray method using a two-fluid nozzle that discharges a fluid mixture of a gas and a liquid. When the two-fluid nozzle is used as the top surface cleaning nozzle 260 shown in FIG. 4, the two-fluid nozzle that sprays the fluid mixture is moved so as to pass through the center of the rotating substrate W from the outside of the substrate W. This allows the fluid mixture including the cleaning liquid or the rinse liquid to be efficiently sprayed over the whole surface of the substrate W. When the two-fluid nozzle is thus used, inert gas such as nitrogen gas (N₂), argon gas, or helium gas must be supplied to the top surface cleaning nozzle 260, as indicated by a dotted line in FIG. 4.

Another Example of the Configuration of the Top Surface and Edge Cleaning/Drying unit

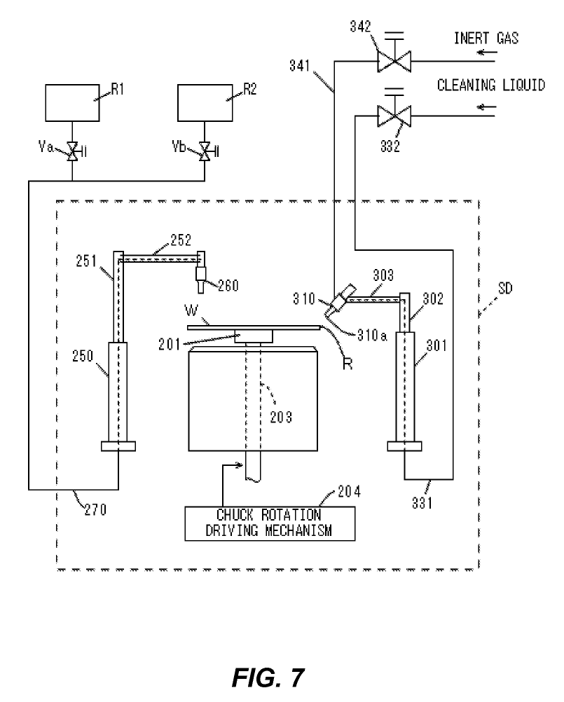

The top surface and edge cleaning/drying unit SD may have the following configuration. FIG. 7 is a diagram for explaining another example of the configuration of the top surface and edge cleaning/drying unit SD. The difference between the top surface and edge cleaning/drying unit SD shown in FIG. 7 and the top surface and edge cleaning/drying unit SD shown in FIG. 4 will be described.

As shown in FIG. 7, in the top surface and edge cleaning/drying unit SD in this example, a two-fluid nozzle 310 is provided as a constituent element for cleaning an edge R of a substrate W in place of the edge cleaning device 210 shown in FIG. 4. Specifically, a motor 301 is provided outside a spin chuck 201. A rotation shaft 302 is connected to the motor 301. An arm 303 is connected to the rotation shaft 302 so as to extend in the horizontal direction, and the two-fluid nozzle 310 is provided at the tip of the arm 303. The two-fluid nozzle 310 discharges a fluid mixture of a gas and a liquid. Note that at the tip of the arm 303, the two-fluid nozzle 310 is attached thereto so as to be inclined to the top surface of the substrate W held by the spin chuck 201.

When top surface and edge cleaning processing of the substrate W is started, the motor 301 causes the rotation shaft 302 to rotate while causing the arm 303 to swing. This causes the two-fluid nozzle 310 to move to above the edge R of the substrate W held by the spin chuck 201 As a result, a discharge section 310a of the fluid mixture in the two-fluid nozzle 310 is opposite to the edge R of the substrate W.

A cleaning liquid supply pipe 331 is provided so as to pass through the motor 301, the rotation shaft 302, and the arm 303. The cleaning liquid supply pipe 331 has its one end connected to the two-fluid nozzle 310 and the other end connected to a cleaning liquid supply system (not shown) through a valve 332. A cleaning liquid is supplied to the two-fluid nozzle 310 through the cleaning liquid supply pipe 331 by opening the valve 332. One end of a gas supply pipe 341, together with the cleaning liquid supply pipe 331, is connected to the two-fluid nozzle 310. The other end of the gas supply pipe 341 is connected to a gas supply system (not shown) through a valve 342. A gas is supplied to the two-fluid nozzle 310 by opening the valve 342. An example of the gas supplied to the two-fluid nozzle 310 is inert gas such as nitrogen gas (N₂), argon gas, or helium gas.

When the substrate W is subjected to the top surface and edge cleaning processing, the cleaning liquid and the gas are supplied to the two-fluid nozzle 310. This causes the cleaning liquid and a rinse liquid to be discharged from the top surface cleaning nozzle 260 to the top surface of the substrate W while causing the fluid mixture to be discharged from the two-fluid nozzle 310 to the edge R of the rotating substrate W.

Thus, a high cleaning effect can be obtained by using the fluid mixture. This causes the edge R of the substrate W to be satisfactorily cleaned. The fluid mixture of the gas and the liquid is discharged to the edge R of the substrate W, so that the edge R of the substrate W is cleaned in non-contact, which prevents the edge R of the substrate W from being damaged during the cleaning. Furthermore, it is also possible to easily control the cleaning conditions of the edge R of the substrate W by controlling the discharge pressure of the fluid mixture and the ratio of the gas and the liquid in the fluid mixture. Furthermore, the two-fluid nozzle 310 allows the uniform fluid mixture to be discharged to the edge R of the substrate W, which prevents the edge R from being non-uniform in cleaning.

The present invention is not limited to the above-mentioned example. For example, in the top surface and edge cleaning/drying unit SD, a ultrasonic nozzle containing a high-frequency vibrator may be used as a constituent element for cleaning the edge R of the substrate W.

### Effects of the First Embodiment

Effects of the Development Processing Block

Generally in the substrate processing apparatus having a plurality of blocks provided side by side therein, a development processing block that subjects the substrate W to development processing is provided with a development processing group for subjecting the substrate W to the development processing and a thermal processing group for subjecting the substrate after the development processing to thermal processing. Furthermore, when the development processing block is provided with a central robot that transports the substrate, the development processing group and the thermal processing group for development are generally provided so as to be opposite to each other with the central robot interposed therebetween.

On the other hand, in the development processing block 13 in the substrate processing apparatus 500 according to the first embodiment, the development processing groups 60a and 60b are provided opposite to each other with the fifth central robot CR5 interposed therebetween. That is, in the development processing block 13, the development processing group 60a is provided at a position of the thermal processing group for development to be generally provided. Thus, the development processing block 13 includes a larger number of (eight) development processing units DEV, as compared with those in the conventional substrate processing apparatus.

Even when a time period required for the development processing is lengthened, therefore, the large number of development processing units DEV can subject a large number of substrates W to development processing, which allows throughput in substrate processing of the whole substrate processing apparatus to be sufficiently improved.

First Effect of the Top Surface and Edge Cleaning Processing

In the substrate processing apparatus 500 according to the first embodiment, the top surface and edge cleaning/drying unit SD in the cleaning/drying processing group 80 subjects the substrate W before the exposure processing to the top surface and edge cleaning processing. This causes the top surface and the edge R of the substrate W carried into the exposure device 17 to be kept clean. As a result, contamination in the exposure device 17 due to contamination on the top surface and the edge R of the substrate W before the exposure processing can be prevented, which can sufficiently prevent a defective dimension and a defective shape of an exposure patter

Second Effect of the Top Surface and Edge Cleaning Processing

In the substrate processing apparatus 500 according to the first embodiment, the top surface and the edge R of the substrate W can be concurrently or simultaneously cleaned in the top surface and edge cleaning/drying unit SD, as described above. This eliminates the necessity of individually cleaning the top surface and the edge R of the substrate W before the exposure processing, which inhibits throughput in substrate processing from being reduced.

The top surface cleaning unit that cleans the top surface of the substrate W and the edge cleaning unit that cleans the edge R of the substrate W need not be individually provided. This causes the cleaning/drying processing block 15 to be miniaturized. Alternatively, throughput in substrate processing can be also further improved by increasing the number of top surface and edge cleaning/drying units SD provided within the cleaning/drying processing block 15. Furthermore, another processing unit can be also provided within the cleaning/drying processing group 80 in the cleaning/drying processing block 15.

In order to previously elude or deposit a component of a film on the substrate W, it is preferable that a liquid used for the liquid immersion method (an immersion liquid) in the exposure device 17 is used as the cleaning liquid used in the above-mentioned top surface and edge cleaning processing. Examples of the immersion liquid include pure water, glycerol with a high refractive index, a liquid mixture of fine particles with a high refractive index (e.g., aluminum oxide) and pure water, and an organic liquid. Other examples of the immersion liquid include a pure water solution containing a complex (ionized), carbonic water, hydrogen water, electrolytic ionic water, HFE (hydrofluoroether), hydrofluoric acid, sulfuric acid, and a sulfuric acid/hydrogen peroxide mixture.

In the present embodiment, before the exposure device 17 subjects the substrate W to the exposure processing, the resist cover film is formed on the resist film in the resist cover film processing block 12. In this case, even if the substrate W is brought into contact with the liquid in the exposure device 17, the resist cover film prevents the resist film from coming into contact with the liquid, which prevents a component of the resist from being eluted in the liquid.

### Second Embodiment

The difference between a substrate processing apparatus according to a second embodiment of the present invention and the substrate processing apparatus 500 according to the first embodiment will be now described.

Configuration of the Substrate Processing Apparatus

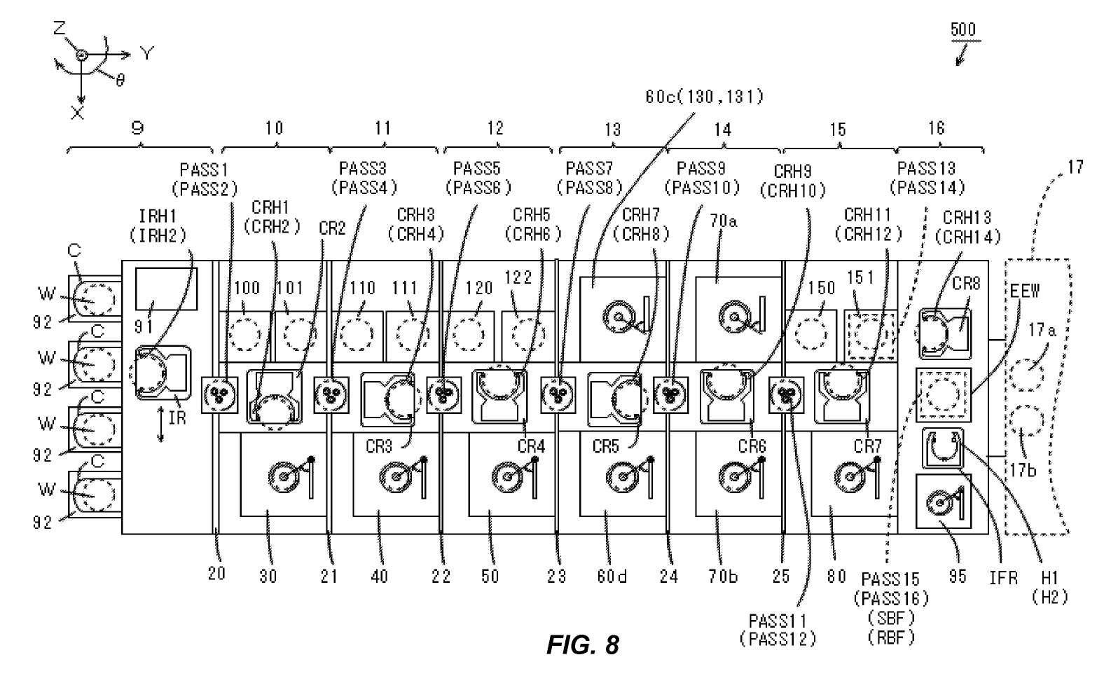

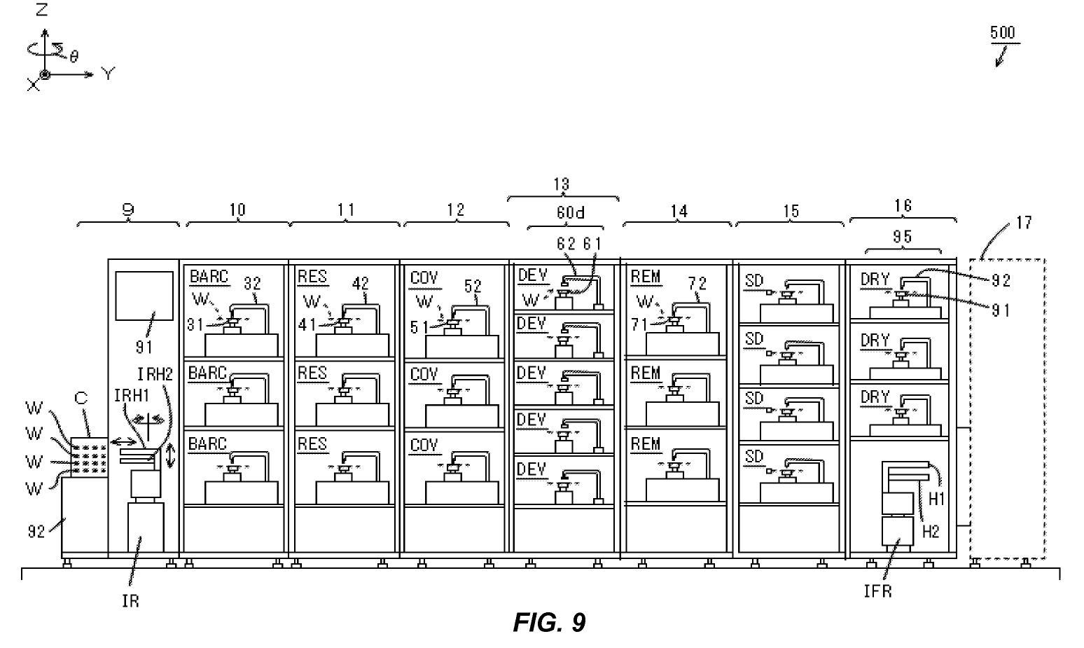

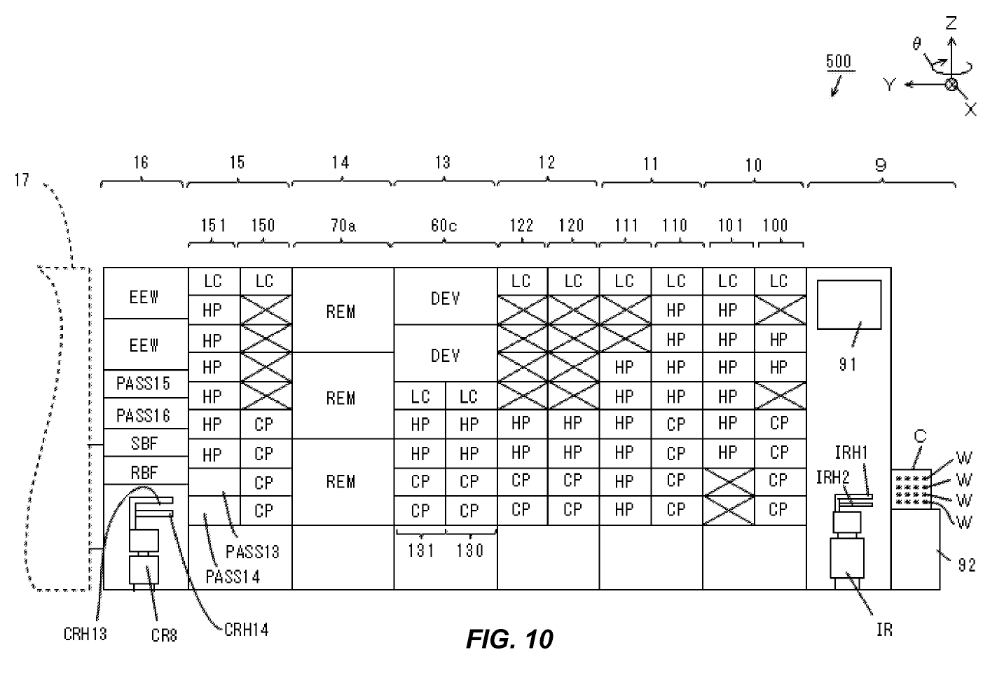

FIG. 8 is a plan view of a substrate processing apparatus 500 according to a second embodiment, FIG. 9 is a side view on one side of the substrate processing apparatus 500 shown in FIG. 8, and FIG. 10 is a side view on the other side of the substrate processing apparatus 500 shown in FIG. 8. As shown in FIGS. 8 to 10, the substrate processing apparatus 500 according to the present embodiment differs from the substrate processing apparatus 500 according to the first embodiment in the configuration of a resist cover film processing block 12.

The resist cover film processing block 12 includes thermal processing groups 120 and 122 for resist cover film, a coating processing group 50 for resist cover film, and a fourth central robot CR4. The coating processing group 50 is provided opposite to the thermal processing groups 120 and 122 with the fourth central robot CR4 interposed therebetween. As shown in FIG. 10, the thermal processing group 122 has a vertical stack of two heating units HP and two cooling units CP.

The substrate processing apparatus 500 according to the present embodiment differs from the substrate processing apparatus 500 according to the first embodiment in the configuration of a development processing block 13. The development processing block 13 includes development processing groups 60c and 60d, thermal processing groups 130 and 131 for development, and a fifth central robot CR5. Here, as shown in FIG. 10, the development processing group 60c is stacked on the thermal processing groups 130 and 131. Thus, in the development processing block 13, the development processing group 60d is provided opposite to the development processing group 60c and the thermal processing groups 130 and 131 with the fifth central robot CR5 interposed therebetween.

As shown in FIG. 9, the development processing group 60d has a vertical stack of five development processing units DEV. As shown in FIG. 10, the development processing group 60c has a vertical stack of two development processing units DEV. Each of the thermal processing groups 130 and 131 has a vertical stack of two heating units HP and two cooling units CP. Each of the thermal processing groups 130 and 131 also has a local controller LC for controlling the respective temperatures of the heating unit HP and the cooling unit CP arranged in its uppermost part.

Operations of the substrate processing apparatus

By the above-mentioned configuration, the substrate processing apparatus 500 according to the present embodiment performs operations different from those in the first embodiment. First, in the second embodiment, carriers C are also respectively placed on carrier platforms 92 in an indexer block 9. An unprocessed substrate W that is stored in the carrier C is received by an indexer robot IR, and is placed on a substrate platform PASS5 by being transported in the same manner as that in the first embodiment.

The substrate W placed on the substrate platform PASS5 is received by a fourth central robot CR4 in the resist cover film processing block 12. The fourth central robot CR4 carries the substrate W into the coating processing group 50. This causes a coating of a resist cover film to be formed on a resist film. Thereafter, the fourth central robot CR4 then takes out the substrate W that has been subjected to coating processing from the coating processing group 50, and carries the substrate W into the thermal processing group 120 or 122. The fourth central robot CR4 then takes out the thermally processed substrate W from the thermal processing group 120 or 122, and places the substrate W on a substrate platform PASS7.

The substrate W placed on the substrate platform PASS7 is received by the fifth central robot CR5 in the development processing block 13, and is transported to an exposure device 17 in the same manner as that in the first embodiment. The substrate W after exposure processing by the exposure device 17 is taken out by an interface transporting mechanism IFR, and is placed on a substrate platform PASS10 by being transported in the same manner as that in the first embodiment.

The substrate W placed on the substrate platform PASS10 is received by the fifth central robot CR5 in the development processing block 13. The fifth central robot CR5 carries the substrate W into the development processing group 60c or 60d. In the development processing groups 60c or 60d, the development processing unit DEW subjects the substrate W to development processing. Thereafter, the fifth central robot CR5 takes out the substrate W that has been subjected to the development processing from the development processing group 60c or 60d, and carries the substrate W into the thermal processing group 130 or 131. The fifth central robot CR5 then takes out the thermally processed substrate W from the thermal processing group 130 or 131, and places the substrate W on a substrate platform PASS8.

The substrate W placed on the substrate platform PASS8 is received by the fourth central robot CR4 in the resist cover film processing block 12. The fourth central robot CR4 places the substrate W on a substrate platform PASS6. The substrate W placed on the substrate platform PASS6 is transported to the indexer block 9 and stored in the carrier C in the same manner as that in the first embodiment.

### Effects of the Second Embodiment

Generally in the substrate processing apparatus having a plurality of blocks provided side by side therein, the development processing block in which the substrate W is subjected to development processing is provided with a development processing group that subjects the substrate W to the development processing and a thermal processing group for subjecting the substrate W after the development processing to thermal processing. Furthermore, when the development processing block is provided with a central robot that transports the substrate W, the development processing group and the thermal processing group for development are generally provided so as to be opposite to each other with the central robot interposed therebetween.

On the other hand, in the development processing block 13 in the substrate processing apparatus 500 according to the second embodiment, the development processing groups 60a and 60b are provided opposite to each other with the fifth central robot CR5 interposed therebetween. Thus, the development processing block 13 includes a larger number of (seven in this example) development processing units DEV, as compared with those in the conventional substrate processing apparatus.

Even when a time period required for the development processing is lengthened, therefore, the large number of development processing units DEV can subject a large number of substrates W to development processing, which allows throughput in substrate processing of the whole substrate processing apparatus to be sufficiently improved. In addition, in the present embodiment, the development processing block 13 includes the thermal processing groups 130 and 131 together with the development processing groups 60c and 60d, so that the substrate W after the development processing can be quickly subjected to thermal processing.

### Third Embodiment

The difference between a substrate processing apparatus according to a third embodiment of the present invention and the substrate processing apparatus 500 according to the first embodiment will be now described.

Configuration of the Substrate Processing Apparatus

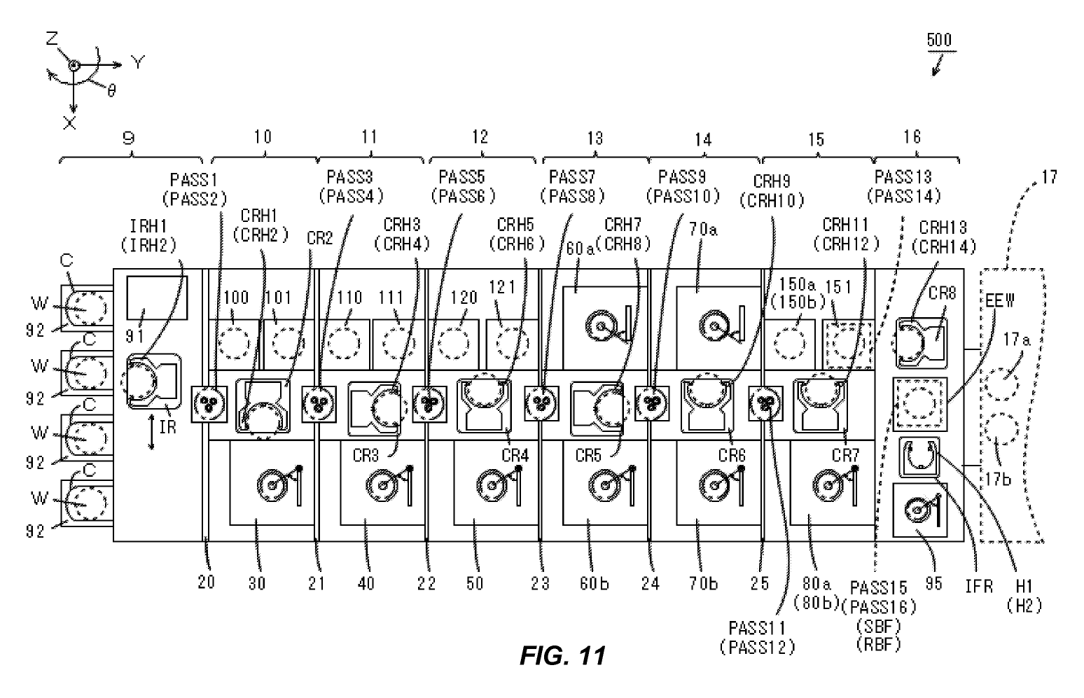

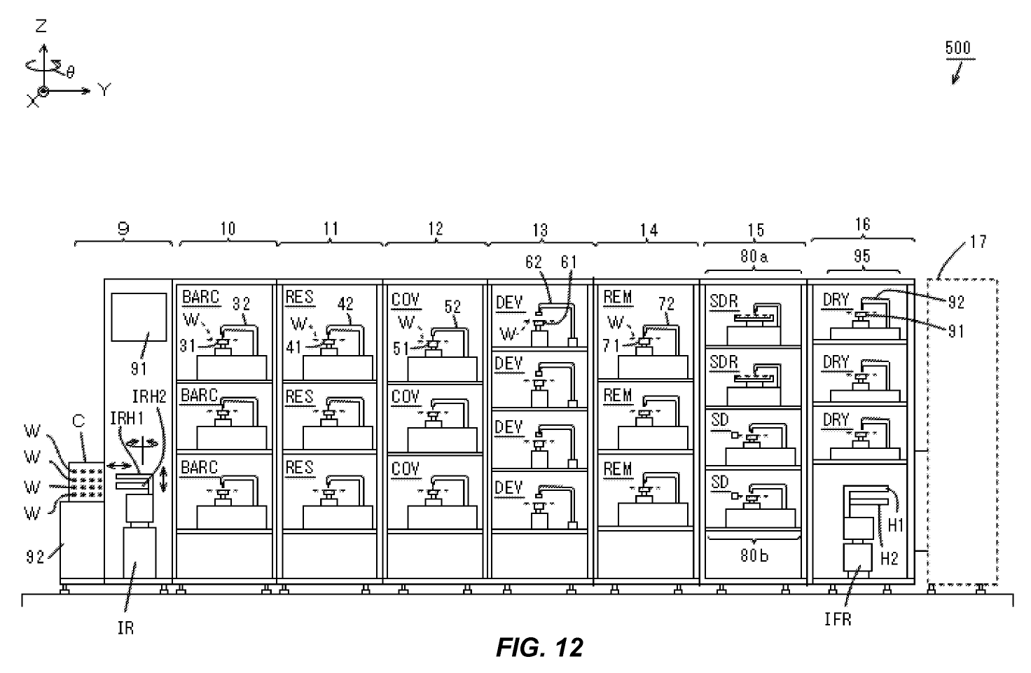

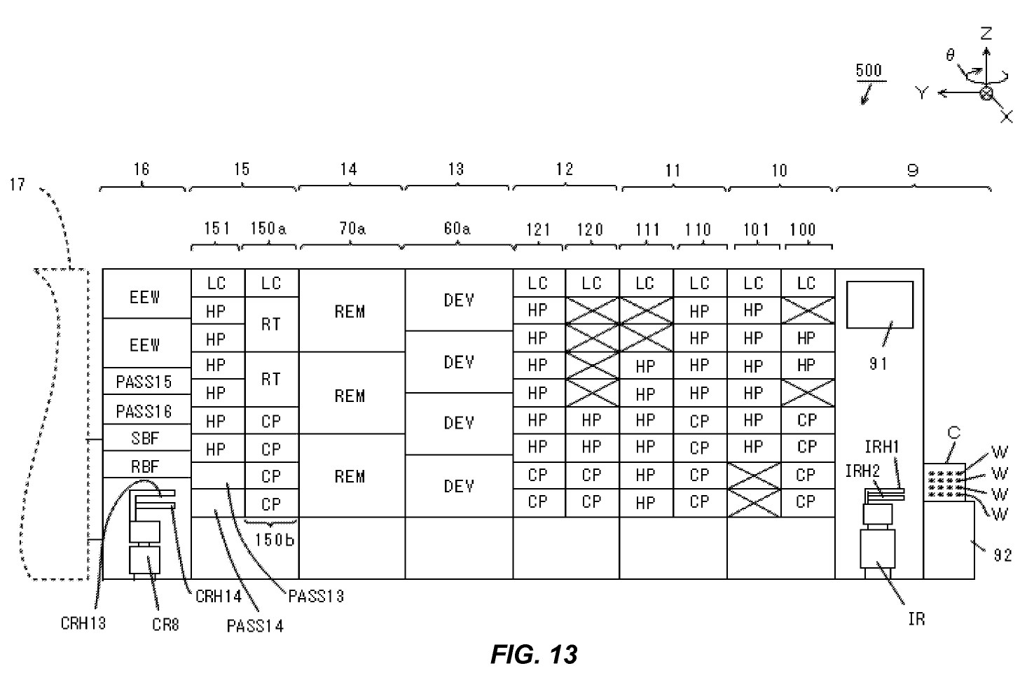

FIG. 11 is a plan view of a substrate processing apparatus according to a third embodiment, FIG. 12 is a side view on one side of the substrate processing apparatus 500 shown in FIG. 11, and FIG. 13 is a side view on the other side of the substrate processing apparatus 500 shown in FIG. 11. As shown in FIGS. 11 to 13, the substrate processing apparatus 500 according to the present embodiment differs from the substrate processing apparatus 500 according to the first embodiment in the configuration of a cleaning/drying processing block 15.

The cleaning/drying processing block 15 includes a substrate reversing group 150a, thermal processing groups 150 and 150 for post-exposure bake, a first cleaning/drying processing group 80a, a second cleaning/drying processing group 80b, and a seventh central robot CR7. The first cleaning/drying processing group 80a and the second cleaning/drying processing group 80b are vertically stacked in this order. The first and second cleaning/drying processing groups 80a and 80b are provided opposite to the substrate reversing group 150a and the thermal processing groups 150 and 151 with the seventh central robot CR7 interposed therebetween.

As shown in FIG. 12, the first cleaning/drying processing group 80a has a vertical stack of two back surface cleaning unit SDRs, and the second cleaning/drying processing group 80b has a vertical stack of two top surface and edge cleaning/drying units SDs. Here, the back surface cleaning unit SDR is used for cleaning a back surface of a substrate W. The substrate W is carried into the back surface cleaning unit SDR with the back surface thereof directed upward. The details of the back surface cleaning unit SDR will be described more fully throughout the present specification and more particularly below.

As shown in FIG. 13, in the cleaning/drying processing block 15, the thermal processing group 151 is provided adjacent to an interface block 16. The thermal processing group 151 has a vertical stack of six heating units HP and substrate platforms PASS13 and PASS14. The thermal processing group 151 has a local controller LC arranged at its uppermost part. The substrate reversing group 150a and the thermal processing group 150b are vertically stacked in this order adjacent to the thermal processing group 151.

The substrate reversing group 150a has a vertical stack of two reversing units RT. The thermal processing group 150b has a vertical stack of four cooling units CP. Furthermore, the substrate reversing group 150a has a local controller LC for controlling the operation of the reversing unit RT and the temperature of the cooling unit CP in the thermal processing group 150b, described later, arranged in its uppermost part. Here, the reversing unit RT is used for reversing one surface (top surface) and the other surface (back surface) of the substrate W. When the top surface of the substrate W is directed upward, for example, the reversing unit RT reverses the substrate W such that the back surface thereof is directed upward. The details of the reversing unit RT will be described later.

Operations of the Substrate Processing Apparatus

By the above-mentioned configuration, operations different from those in the first embodiment are performed in the substrate processing apparatus 500 according to the present embodiment. First, in the third embodiment, carriers C are also respectively placed on carrier platforms 92 in an indexer block 9. Here, in the present embodiment, a plurality of substrates W that are stored in each of the carriers C are held with their top surfaces directed upward. The unprocessed substrate W that is stored in the carrier C is received by an indexer robot IR, and is placed on a substrate platform PASS11 by being transported in the same manner as that in the first embodiment.

The substrate W placed on the substrate platform PASS11 is received by the seventh central robot CR7 in the cleaning/drying processing block 15. The seventh central robot CR7 carries the substrate W into the top surface and edge cleaning/drying unit SD in the second cleaning/drying processing group 80b. In the top surface and edge cleaning/drying processing unit SD, the substrate W is subjected to top surface and edge cleaning processing, as in the first embodiment. This causes the top surface and an edge of the substrate W before exposure processing by an exposure device 17 to be kept clean. Thereafter, the seventh central robot CR7 takes out the substrate W that has been subjected to the top surface and edge cleaning processing from the top surface and edge cleaning/drying unit SD, and carries the substrate W into the reversing unit RT in the substrate reversing group 150a.

The reversing unit RT reverses one surface and the other surface of the substrate W, as described above. That is, the reversing unit RT reverses the substrate W whose top surface is directed upward such that the back surface thereof is directed upward. Subsequently, the seventh central robot CR7 takes out the substrate W whose back surface is directed upward from the reversing unit RT, and carries the substrate W into the back surface cleaning unit SDR in the first cleaning/drying processing group 80a. The back surface cleaning unit SDR cleans the back surface of the substrate W, as described above. Then, the seventh central robot CR7 takes out the substrate W whose back surface has been cleaned from the back surface cleaning unit SDR, and carries the substrate W into the reversing unit RT in the substrate reversing group 150a.

Therefore, the reversing unit RT reverses the substrate W whose back surface is directed upward such that the top surface thereof is directed upward. The seventh central robot CR7 takes out the substrate W whose top surface is directed upward from the reversing unit RT, and places the substrate W on the substrate platform PASS13. The substrate W placed on the substrate platform PASS13 is transported to the exposure device 17 in the same manner as that in the first embodiment. Thus, the exposure device 17 subjects the substrate W to exposure processing. The substrate W after the exposure processing is carried into the indexer block 9 and stored in the carrier C in the same manner as that in the first embodiment.

As to the Back Surface Cleaning Unit

The back surface cleaning unit SDR will be herein described in detail with reference to the drawings. Note that the operation of each of constituent elements in the back surface cleaning unit SDR, described below, is controlled by the main controller (controller) 91 shown in FIG. 11.

Configuration of the Back Surface Cleaning Unit

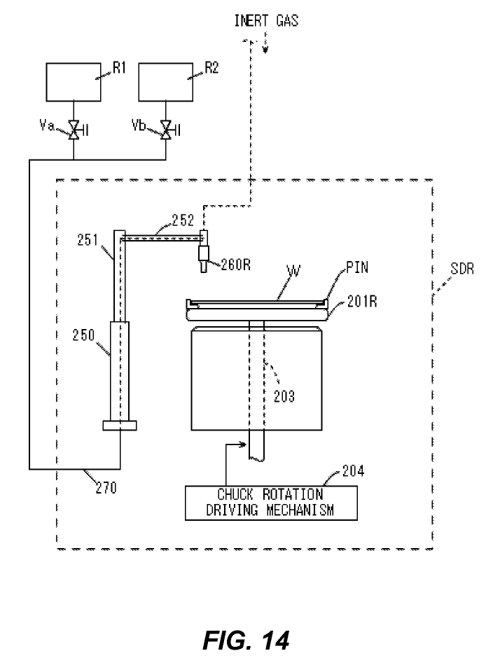

FIG. 14 is a diagram for explaining the configuration of the back surface cleaning unit SDR. The back surface cleaning unit SDR cleans a back surface of a substrate W (back surface cleaning processing). As shown in FIG. 14, the back surface cleaning unit SDR includes a mechanical spin chuck 201R for rotating the substrate W about a vertical axis passing through the center of the substrate W while horizontally holding the substrate W. The spin chuck 201R holds an outer peripheral portion of the substrate W. The spin chuck 201R is secured to an upper end of a rotation shaft 203 that is rotated by a chuck rotation driving mechanism 204.

As described in the foregoing, the substrate W is carried into the back surface cleaning unit SDR with the back surface thereof directed upward. Therefore, the substrate W is held by the spin chuck 201R with the back surface thereof directed upward. At the time of the back surface cleaning processing, the substrate W is rotated while maintaining a horizontal attitude with a peripheral portion on its lower surface and the outer peripheral portion held by a spin holding pin PIN on the spin chuck 201R.

A motor 250 is provided outside the spin chuck 201R, as in the top surface and edge cleaning/drying unit SD. A rotation shaft 251 is connected to the motor 250. An arm 252 is connected to the rotation shaft 251 so as to extend in the horizontal direction, and its tip is provided with a back surface cleaning nozzle 260R. The motor 250 causes the rotation shaft 251 to rotate while causing the arm 252 to swing. This allows the back surface cleaning nozzle 260R to move between an upper position and an outer position of the substrate W held by the spin chuck 201R.

A supply pipe 270 for cleaning processing is provided so as to pass through the motor 250, the rotation shaft 251, and the arm 252. The supply pipe 270 is connected to a cleaning liquid supply source R1 and a rinse liquid supply source R2 through a valve Va and a valve Vb, respectively, as in the top surface and edge cleaning/drying unit SD. By controlling the opening and closing of the valves Va and Vb, it is possible to supply a cleaning liquid or a rinse liquid to the back surface of the substrate W through the supply pipe 270 and the back surface cleaning nozzle 260R. This allows the back surface of the substrate W to be cleaned.

Operations of the Back Surface Cleaning Unit

When the substrate W is carried into the back surface cleaning unit SDR, the seventh central robot CR7 shown in FIG. 11 places the substrate W on the spin chuck 201R. The substrate W placed on the spin chuck 201 is held by the spin chuck 201R. The back surface cleaning nozzle 260R then moves to above the center of the substrate W. The rotation shaft 203 rotates so that the substrate W rotates. In this state, the cleaning liquid is discharged to the back surface of the substrate W from the back surface cleaning nozzle 260R. This causes the back surface of the substrate W to be cleaned.

After an elapse of a predetermined time period, the back surface cleaning nozzle 260R discharges the rinse liquid to the back surface of the substrate W in place of the cleaning liquid. This causes the cleaning liquid supplied onto the substrate W to be cleaned away. Furthermore, after an elapse of a predetermined time period, the back surface cleaning nozzle 260R moves outward apart from the substrate W held by the spin chuck 201R after stopping to discharge the rinse liquid to the substrate W.

The number of revolutions of the rotation shaft 203 increases. This causes a great centrifugal force to act on the rinse liquid remaining on the substrate W. Thus, a liquid that adheres to the back surface and the edge of the substrate W is scattered, so that the substrate W is dried. In the back surface cleaning unit SDR, the cleaning liquid and the rinse liquid may be also supplied onto the substrate W by means of a soft spray method using a two-fluid nozzle that discharges a fluid mixture of a gas and a liquid. When the two-fluid nozzle is used, inert gas such as nitrogen gas (N₂), argon gas, or helium gas must be supplied, as indicated by a dotted line in FIG. 14, to the back surface cleaning nozzle 260R.

As to the Reversing Unit

The reversing unit RT will be herein described in detail with reference to the drawings. Note that the operation of each of constituent elements in the reversing unit RT, described below, is controlled by the main controller (controller) 91 shown in FIG. 11.

Configuration of the Reversing Unit

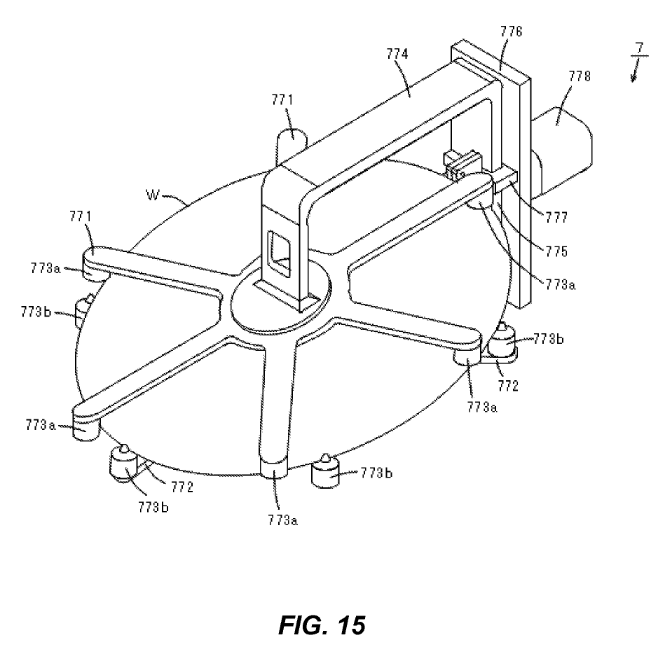

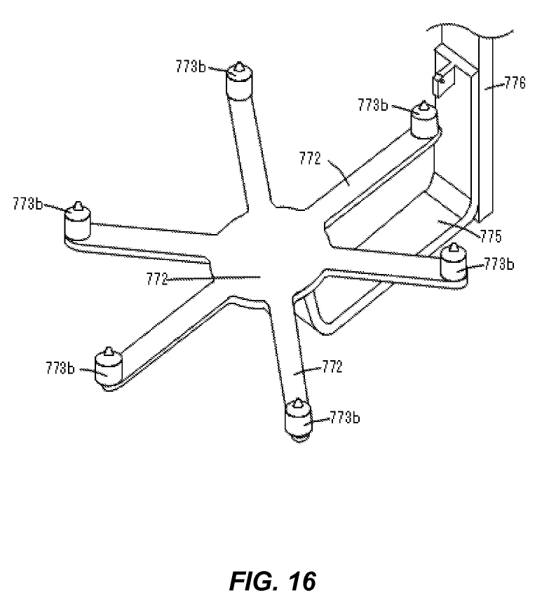

FIG. 15 is a perspective view showing the appearance of a substrate reversing device 7 provided in the reversing unit RT, and FIG. 16 is a perspective view showing the appearance of a part of the substrate reversing device 7. As shown in FIGS. 15 and 16, the substrate reversing device 7 includes a first supporting member 771, a second supporting member 772, a plurality of substrate support pins 773a and 773b, a first movable member 774, a second movable member 775, a fixed plate 776, a rink mechanism 777, and a rotating mechanism 778.

As shown in FIG. 16, the second supporting member 772 is composed of six stick-shaped members radially extending. Each of the six stick-shaped members has the substrate support pin 773b provided at its tip. Similarly, as shown in FIG. 15, the first supporting member 771 is also composed of six stick-shaped members radially extending. Each of the six stick-shaped members has the substrate support pin 773a provided at its tip.

Although in the present embodiment, each of the first and second supporting members 771 and 772 is composed of six stick-shaped members, the present invention is not limited to the same. Each of the first and second supporting members 771 and 772 may be composed of stick-shaped members in any other number or members in any other shape. For example, the first and second supporting members 771 and 772 may be respectively formed in other shapes such as disk shapes or polygonal shapes having outer peripheries along the plurality of first and second substrate support pins 773a and 773b.

The first movable member 774 has a U shape. The first supporting member 771 is fixed to one end of the first movable member 774. The other end of the first movable member 774 is connected to the link mechanism 777. Similarly, the second movable member 775 has a U shape. The second supporting member 772 is fixed to one end of the second movable member 775. The other end of the second movable member 775 is connected to the link mechanism 777. The link mechanism 777 is attached to a rotation axis of the rotating mechanism 778. The link mechanism 777 and the rotating mechanism 778 are attached to the fixed plate 776.

The link mechanism 777 shown in FIG. 15 contains an air cylinder or the like, which allows the first movable member 774 and the second movable member 775 to move to a relatively spaced state and a closely-spaced state. Furthermore, the rotating mechanism 778 shown in FIG. 15 contains a motor or the like, which allows the first movable member 774 and the second movable member 775 to rotate through an angle of 180°, for example, about a horizontal axis through the link mechanism 777.

Operations of the Reversing Unit

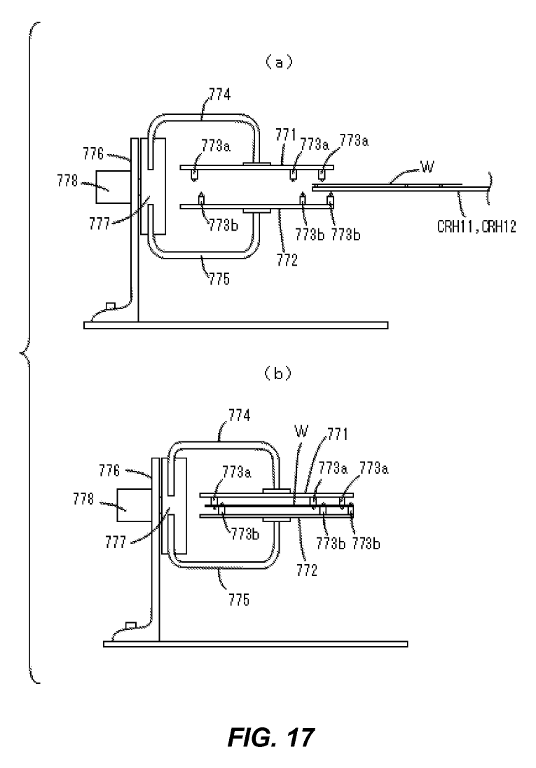

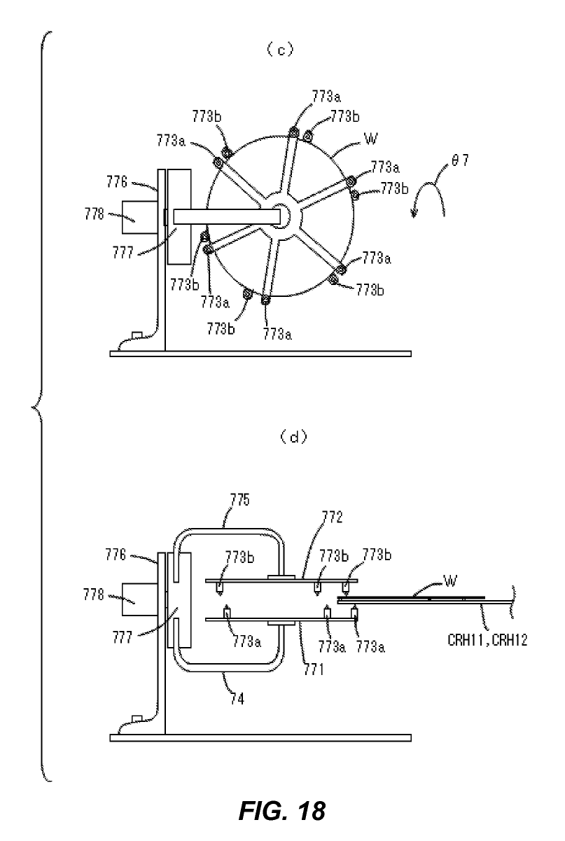

FIGS. 17 and 18 are schematic views showing the operations of the substrate reversing device 7 shown in FIG. 15. First, as shown in FIG. 17 (a), the seventh central robot CR7 shown in FIG. 12 carries the substrate W into the substrate reversing device 7. In this case, the action of the link mechanism 777 causes the first movable member 774 and the second movable member 775 to be held in a vertically spaced state.

The hands CRH1 and CRH12 of the seventh central robot CR7 transfer the substrate W onto the plurality of substrate support pins 773 in the second supporting member 772. After the substrate W is transferred, the hands CRH11 and CRH12 of the seventh central robot CR7 exit from the substrate reversing device 7. Then, as shown in FIG. 17(b), the action of the link mechanism 777 causes the first movable member 774 and the second movable member 775 to move to a vertically closely-spaced state. Subsequently, as shown in FIG. 18(c), the action of the rotating mechanism 778 causes the first movable member 774 and the second movable member 775 to rotate through an angle of 180° in a direction indicated by an arrow θ7 about a horizontal axis.

In this case, the substrate W, together with the first movable member 774 and the second movable member 775, rotates through an angle of 180° while being held by the plurality of substrate support pins 773a and 773b respectively provided in the first supporting member 771 and the second supporting member 772. Finally, the action of the link mechanism 777 causes the first movable member 774 and the second movable member 775 to move to a vertically spaced state. The hands CRH11 and CRH12 of the seventh central robot CR7 enter the substrate reversing device 7, and exit therefrom with the substrate W held, as shown in FIG. 18(d).

### Effects of the Third Embodiment

In the substrate processing apparatus 500 according to the third embodiment, the substrate W before the exposure processing is subjected to the top surface and edge cleaning processing by the top surface and edge cleaning/drying unit SD in the second cleaning/drying processing group 80b, and is subjected to the back surface cleaning processing by the back surface cleaning unit SDR in the first cleaning/drying processing group 80a.

Thus, the top surface, the back surface, and the edge of the substrate W before the exposure processing by the exposure device 17 are cleaned. This causes the top surface, the back surface, and the edge of the substrate W carried into the exposure device 17 to be kept clean. As a result, contamination in the exposure device 17 due to contamination on the top surface, the back surface, and the edge of the substrate W before the exposure processing can be further sufficiently prevented, which can more sufficiently prevent a defective dimension and a defective shape of an exposure pattern.

Although the back surface of the substrate W is held by suction on the spin chuck 201 (FIG. 4) during the top surface and edge cleaning processing, the back surface cleaning processing is quickly performed after the top surface and edge cleaning processing. Therefore, suction marks on the back surface of the substrate W are easily removed.

### Another Embodiment and Effects Thereof

As to the Resist Cover Film

In each of the substrate processing apparatuses 500 according to the first to third embodiments, the resist cover film processing block 12 and the resist cover film removal block 14 need not be provided in the substrate processing apparatus 500, provided that a component of a resist is not eluted in a liquid used in the exposure device 17 even if the resist film formed on the top surface of the substrate W and the liquid are brought into contact with each other. In this case, by removing each of the blocks 12 and 14, the miniaturization of the substrate processing apparatus 500 and the reduction of a foot print are realized, and throughput in substrate processing is further improved.

Another Example of Arrangement

Although in the first to third embodiments, the resist cover film removal block 14 includes the two resist cover film removal processing groups 70a and 70b, the resist cover film removal block 14 may include a thermal processing group that subjects the substrate W to thermal processing in place of one of the two resist cover film removal processing groups 70a and 70b. In this case, the plurality of substrates W are efficiently subjected to thermal processing, so that throughput in substrate processing is improved.

As to the Exposure Device

In each of the above-mentioned embodiments, the exposure device 17 may subject the substrate W to the exposure processing without using the liquid immersion method. In this case, the object of the present invention can be achieved by providing the substrate processing apparatus 500 with a development processing block 13 in which development processing units DEV are arranged opposite to each other with a central robot interposed therebetween.

Correspondences Between Elements in the Claims and Parts in Embodiments

In the following paragraphs, non-limiting examples of correspondences between various elements recited in the claims below and those described above with respect to various preferred embodiments of the present invention are explained.

In the embodiments described above, the anti-reflection film processing block 10, the resist film processing block 11, the resist cover film processing block 12, the development processing block 13, the resist cover film removal block 14, and the cleaning/drying processing block 15 are examples of a processing section, the indexer block is an example of a carry-in/carry-out section, and the interface block 16 is an example of an interface unit.

The resist film processing block 11 is an example of a first processing unit, the development processing block 13 is an example of a second processing unit, the coating processing group 40 for resist film is an example of a photosensitive film formation region, the thermal processing groups 110 and 111 for resist film are examples of a thermal processing region, and an installation region of the third central robot CR3 is an example of a first transport region.

Furthermore, the resist film is an example of a photosensitive film, the coating unit RES is an example of a photosensitive film formation unit, the heating unit HP and the cooling unit CP in the thermal processing groups 110 and 111 for resist film are example of a first thermal processing unit, and the third central robot CR3 is an example of a first transport unit.

The development processing groups 60a to 60d are examples of first and second development regions, an installation region of the fifth central robot CR5 is an example of a second transport region, the development processing unit DEV is an example of a development unit, and the fifth central robot CR5 is an example of a second transport unit.

Furthermore, the heating plate HP and the cooling plate CP in the processing groups 130 and 131 for development are examples of a second thermal processing unit, the processing block 10 for anti-reflection film is an example of a third processing unit, the coating processing group 30 for anti-reflection film is an example of an anti-reflection film formation region, an installation region of the second central robot CR2 is an example of a third transport region, the coating unit BARC is an example of an anti-reflection film formation unit, and the second central robot CR2 is an example of a third transport unit.

The resist cover film processing block 12 is an example of a fourth processing unit, the coating processing group 50 for resist cover film is an example of a protective film formation region, an installation region of the fourth central robot CR4 is an example of a fourth transport region, the coating unit COV is an example of a protective film formation unit, and the fourth central robot CR4 is an example of a fourth transport unit.

Furthermore, the resist cover film removal block 14 is an example of a fifth processing unit, the removal processing groups 70a and 70b for resist cover film are examples of a protective film removal region, an installation region of the sixth central robot CR6 is an example of a fifth transport region, the removal unit REM is an example of a protective film removal unit, and the sixth central robot CR6 is an example of a fifth transport unit.

The cleaning/drying processing block 15 is an example of a sixth processing unit, the cleaning/drying processing group 80a, the first cleaning/drying processing group 80a, and the second cleaning/drying processing group 80b are examples of a pre-exposure cleaning region, and an installation region of the seventh central robot CR7 is an example of a sixth transport region.

Furthermore, the top surface and edge cleaning/drying unit SD and the back surface cleaning unit SDR are examples of a pre-exposure cleaning unit, the seventh central robot CR7 is an example of a sixth transport unit, the substrate reversing group 150a is an example of a reversing region, and the post-exposure cleaning/drying processing group 95 is an example of a cleaning/drying unit, and the eighth central robot CR8 and the interface transporting mechanism IFR are examples of an interface.

As the elements recited in the claims, various other elements having the structure or function recited in the claims may be employed. While preferred embodiments of the present invention have been described above, it is to be understood that variations and modifications will be apparent to those skilled in the art without departing the scope and spirit of the present invention. The scope of the present invention, therefore, is to be determined solely by the following claims.

What is claimed is:

1. A substrate processing apparatus arranged adjacent to an exposure device, the substrate processing apparatus comprising:
a processing section configured to subject a substrate to predetermined processing, wherein the processing section includes:
a first processing unit comprising a photosensitive film formation region, a thermal processing region having a first thermal processing unit configured to subject the substrate to thermal processing, and a first transport region having a first transport unit configured to transport the substrate, wherein the photosensitive film formation region is arranged opposite the thermal processing region with the first transport region interposed therebetween; and
a second processing unit comprising a first development region having a first development unit, a second development region having a second development unit, and a second transport region having a second transport unit configured to transport the substrate, wherein the first development region is arranged opposite to the second development region with the second transport region interposed therebetween;
a transfer section configured to carry the substrate into and out of the processing section; and
an interface configured to receive and transfer the substrate between the processing section and the exposure device.

2. The substrate processing apparatus of claim 1 wherein the photosensitive film formation region is provided with a photosensitive film formation unit configured to form a photosensitive film composed of a photosensitive material on the substrate that has not been subjected to exposure processing by the exposure device.

3. The substrate processing apparatus of claim 1 wherein the first development unit and the second development unit are configured to subject the substrate to development processing after exposure processing by the exposure device.

4. The substrate processing apparatus of claim 1 wherein at least one of the first development region and the second development region further comprises a second thermal processing unit configured to subject the substrate to thermal processing.

5. The substrate processing apparatus of claim 1 wherein the processing section further includes a third processing unit having an anti-reflection film formation region and a third transport region.

6. The substrate processing apparatus of claim 5 wherein:
the anti-reflection film formation region includes an anti-reflection film formation unit configured to form an anti-reflection film on the substrate before a photosensitive film is formed using the photosensitive film formation unit; and
the third transport region includes a third transport unit configured to transport the substrate.

7. The substrate processing apparatus of claim 1 wherein the processing section further includes a fourth processing unit having a protective film formation region including a protective film formation unit configured to form a protective film for protecting the photosensitive film before exposure processing by the exposure device and a fourth transport region having a fourth transport unit configured to transport the substrate.

8. The substrate processing apparatus of claim 7 wherein the processing section further includes a fifth processing unit including a protective film removal region and a fifth transport region including a fifth transport unit.

9. The substrate processing apparatus of claim 8 wherein the protective film removal region includes a protective film removal unit configured to remove the protective film after exposure processing by the exposure device and before development processing by the development unit.

10. The substrate processing apparatus of claim 1 wherein the processing section further includes a sixth processing unit having a pre-exposure cleaning region and a sixth transport region having a sixth transport unit configured to transport the substrate.

11. The substrate processing apparatus of claim 10 wherein the pre-exposure cleaning region includes a pre-exposure cleaning unit configured to clean the substrate before exposure processing by the exposure device.

12. The substrate processing apparatus of claim 11 wherein the pre-exposure cleaning unit includes a top surface and edge cleaning unit configured to clean a top surface and an edge of the substrate before exposure processing by the exposure device.

13. The substrate processing apparatus of claim 10 wherein the sixth processing unit further includes a reversing region having a reversing unit configured to reverse one surface and the other surface of the substrate

14. The substrate processing apparatus of claim 13 wherein the pre-exposure cleaning unit includes a back surface cleaning unit configured to clean a back surface of the substrate.

15. The substrate processing apparatus of claim 1 wherein the interface includes a cleaning/drying unit configured to clean and dry the substrate after exposure processing by the exposure device.

16. The substrate processing apparatus of claim 15 wherein the interface further includes an interface unit configured to transport the substrate.
